(19) United States
(12) Patent Application Publication
(10) Pub. No.: US 2013/0260302 A1
(43) Pub. Date: Oct. 3, 2013

(54) TONER FOR FORMING IMAGE, IMAGE FORMING METHOD, AND IMAGE FORMING APPARATUS

(71) Applicants: Hisashi Nakajima, Shizuoka (JP); Saori Yamada, Shizuoka (JP); Masashi Nagayama, Shizuoka (JP); Mariko Takii, Shizuoka (JP); Shinya Hanatani, Kanagawa (JP)

(72) Inventors: Hisashi Nakajima, Shizuoka (JP); Saori Yamada, Shizuoka (JP); Masashi Nagayama, Shizuoka (JP); Mariko Takii, Shizuoka (JP); Shinya Hanatani, Kanagawa (JP)

(21) Appl. No.: 13/826,742

(22) Filed: Mar. 14, 2013

(30) Foreign Application Priority Data
Mar. 29, 2012 (JP) 2012-076205
Mar. 30, 2012 (JP) 2012-079706

(51) Int. Cl. G03G 9/087

(52) U.S. Cl. CPC G03G 9/08755
USPC 430/108.2; 430/109.4; 430/108.3; 430/124.1; 399/252

(57) ABSTRACT

A toner, including: crystalline resin; non-crystalline resin; and a composite resin, wherein the crystalline resin is crystalline polyester resin (A), the non-crystalline resin comprises: non-crystalline resin (B) containing chloroform insoluble matter; and non-crystalline resin (C) having a softening temperature (T½) lower than that of the non-crystalline resin (B) by 25° C. or more, an absolute value |Tgc−Tgb| of a difference between a glass transition temperature (Tgc) of non-crystalline resin (C) and a glass transition temperature (Tgb) of non-crystalline resin (B) is 10° C. or lower, wherein the composite resin is composite resin (D) containing a condensation polymerization resin unit and an addition polymerization resin unit, and the toner has a molecular weight distribution having a main peak in 1,000 to 10,000 and a half width of 15,000 or less, where the molecular weight distribution is obtained by gel permeation chromatography (GPC) of tetrahydrofuran (THF) soluble matter of the toner.

### BACKGROUND OF THE INVENTION

1. Field of the Invention

The present invention relates to a toner for forming an image in electrophotography, an image forming method, and an image forming apparatus.

2. Description of the Related Art

Recently, an image forming method using electrophotography has been demanded to form images of high quality, to save energy and to increase speed as well.

Energy is generally saved by improving the properties of fixing toner at low temperatures and thus saving energy consumed for fixing images. However, when images are formed at high speed, image quality deteriorates.

There are various causes for the quality deterioration of images due to high-speed image formation. Among them, defective fixing during a fixing process is the most significant cause.

Unfixed toner images on a recording medium such as paper are fixed on the recording medium with heat and pressure during a fixing process, and then, turned into fixed images. However, when system speed increases, the fixing period decreases and unfixed toner images do not obtain sufficient heat during the fixing process; as a result, defective fixing occurs, and final toner images turn out with rough surfaces and a residual image phenomenon called cold offset occurs, thus providing poor images.

Thus, when system speed is increased, the fixing temperature also needs to be raised so as not to deteriorate image quality. It becomes difficult to save energy and increase speed at the same time and a toner that can be sufficiently fixed at a lower temperature is demanded.

The toner that can be fixed at a low temperature can be prepared by using, for instance, a binder resin having a low glass transition temperature (Tg) and softening temperature (T½). However, such a toner is low in heat-resistant storage stability and offset resistance and also has soft toner particles, so that the toner is stressed in forming images at high speed and fixes to the surface of a developing sleeve, thus staining the sleeve.

Accordingly, when the developing sleeve is stained, the potential of a developer or the like changes, which often causes ghosting (phenomenon of repeating a preceding image history onto the following image).

In the two-component developing system, a magnetic brush is formed with magnets inside a developing sleeve, and electrostatic latent images formed on an electrostatic latent image bearing member are brushed for development in a developing area facing the electrostatic latent image bearing member. By providing the magnets in odd numbers and a pair of magnets in the same pole to a location lower than the rotary shaft of the developing sleeve, a developer releasing area that has nearly zero magnetic force is formed and the developer is naturally dropped by gravity after development in the area, thus releasing the developer from the developing sleeve.

In the two-component developing system, a magnetic carrier is generated with a counter charge during a toner consumption period at a preceding image, and an image force is generated between the carrier and the developing sleeve. At a developer releasing pole that is provided inside the developing sleeve and that has nearly zero magnetic force, the developer is not released normally, and the developer that has lower developing capacity with less toner and toner density is again conveyed to a developing area, thereby generating abnormal images with lower image density at a preceding image forming portion.

In other words, while an image of a normal density can be formed for one circle around the sleeve, ghosting (phenomenon of repeating a preceding image history onto the following image) occurs at two circles and the following circles around the sleeve, so that image density becomes thin at a preceding image forming portion.

Ghosting also occurs when toner fixes onto the developing sleeve on the basis of a preceding image history and the developing amount of toner for the next image changes on the basis of the toner's potential. Specifically, toner is fixed onto the developing sleeve since bias is applied toward the developing sleeve direction during a period of non-image formation and the toner is then developed on the developing sleeve. The toner that is developed on the developing sleeve has a potential, so that a development potential is leveled by a potential that the toner on the developing sleeve has, during a printing period and thus the developing amount of toner increases.

Additionally, as the toner on the developing sleeve is consumed depending on the formed images, the toner amount on the developing sleeve changes on the basis of the history of the formed images. Then, when toner is evenly supplied to the developing sleeve, a toner amount on the developing sleeve increases and image density thus increases in the case that the preceding image is a non-image or at a location right after a space between two pieces of paper. On the contrary, when the preceding image has a large image area, the toner amount on the developing sleeve decreases because more toner is consumed, thereby reducing image density.

In order to solve this problem, Japanese Patent Application Laid-Open (JP-A) No. 11-65247, for example, describes a configuration in which a draw-up roll having an internal magnet is arranged near a releasing area on the developing sleeve and a developer is released after development by magnetic force. Then, after the developer is released from the developing sleeve by the draw-up roll, the developer is carried up by another draw-up roll and then conveyed to a developer agitation chamber with a screw, thereby re-adjusting toner density and charging the toner.

The ghosting is found not only in the two-component developing system but also in a hybrid developing system and a one-component developing system. However, ghosting in these systems results from different mechanical causes.

The hybrid developing system is based on the one-component developing system but has a better developing capacity. In the system, included are a developing sleeve that faces an image bearing member such as a photoconductor and carries toner, and a developer transfer roller that faces the developing sleeve and carries a two-component developer containing a toner and a magnetic carrier, thus supplying a large amount of the developer by a magnetic brush formed at the developer transfer roller to the developing sleeve and then forming a toner layer on the developing sleeve. In such a hybrid developing system, only the toner is supplied to the developing sleeve, and no counter charge is generated at the magnetic carrier in the development area, as in the one-component developing system.

In the hybrid developing system, ghosting occurs as a fixed amount of toner is always supplied to the developing sleeve regardless of the toner consumption of the developing sleeve and the toner amount on the developing sleeve changes on the basis of the consumption of the toner.

Specifically, when the preceding image is printed out with a smaller amount of toner, the amount of toner left on the developing sleeve increases. After the toner is supplied, an amount of toner on the developing sleeve becomes more than a desirable level and images become dark. On the other hand, after printing images with a large amount of toner, residual toner on the developing sleeve is small, so that even when the toner is supplied, a toner amount on the developing sleeve becomes smaller than a desirable level and images become light.

As described above, ghost images in hybrid development are caused since it is difficult to repeatedly coat toner to make toner amounts even at sections where the toner is developed and is not left on the developing sleeve, and at sections where the toner is not developed and is still left on the developing sleeve in the process of transferring the toner from the developer transfer roller onto the developing sleeve, and thus toner amounts on the developing sleeve during the process of printing following images change on the basis of the history of the preceding image.

In order to solve the problems described above, for instance, Japanese Patent Application Publication (JP-B) No. 3356948 and JP-A Nos. 2005-157002 and 11-231652 propose that residual toner on a developing sleeve be scraped with a scraper or a toner recovery roll after developing the toner and before re-supplying the toner.

Moreover, JP-A No. 07-72733 proposes a method that utilizes a space between copies or sheets of paper so as to recover a residual toner on a developing sleeve onto a magnetic roller with a potential difference, thus stabilizing toner amounts on the developing sleeve.

Furthermore, as for a solution against the hysteresis that is found when a magnetic brush is formed on a developer transfer roll, JP-A No. 07-128983 proposes a half width region of a magnetic flux density of a magnetic roller to be wide, so as to recover and supply the toner on a developing roller.

Additionally, JP-A No. 07-92813 proposes a method in which a non-spherical carrier is used as a carrier for electrically charging toner on a developer transfer roller so as to inject electric charge to a carrier up to a tip of a magnetic brush, and thus to set a real gap between developing sleeves narrow, thus increasing each amount of toner supplied to the developing sleeve and supplying the toner up to a toner saturation amount on the developing sleeve. Accordingly, a toner amount on a developing sleeve is kept constant without being influenced by the history of a preceding image.

Also, JP-A No. 07-281517 proposes a method of suppressing ghosts by forming a film made of molybdenum on the surface of a developing sleeve in the one-component developing system. However, this method intends to prevent an increase in electric charge amount that is caused by dragging a developer around with a developing sleeve and repeatedly brushing the developer with the developing sleeve, and is not an effective method for the two-component developing system.

Moreover, JP-A No. 2003-76132 proposes the use of a developing sleeve in which an electric Cr plating layer and an electroless Ni—P layer are provided on an aluminum base in order to prevent gaps between an electrostatic latent image bearing member and a developer carrying member from becoming partially uneven, since a highly abrasion-resistant plating layer that prevents the abrasion of an uneven surface of a developer carrying member roughened for one-component development, is formed by heating and thus a base is deformed with heat. However, this method is not an effective solution for residual images in the two-component developing system.

Also, JP-A No. 2007-121561 proposes the method of providing a metal layer having mirror-finished glossiness on the surface of a base so as to control the roughness of a developing sleeve. Provided herein is a description that the effect is obtained even with a two-component developer. However, JP-A No. 2007-121561 describes only the examples of the one-component developing system. Also, as it is mentioned that “in general, when the charging property of a surface layer is increased, images become darker” herein, this concerns the one-component developing system and is not an effective solution for residual images in the two-component developing system.

Moreover, in the hybrid developing system and the one-component developing system, the outer surface of a developing sleeve is sand-blasted or is formed with grooves so as to prevent a developer from slipping on a developing sleeve that is rotating at high speed. Thus, the deterioration of image density, caused by the developer that is left due to slippage, is prevented.

However, since the unevenness on the outer surface is extremely fine, it is gradually ground with a developer or the like, so that the unevenness is ground and the sand-blasted developing sleeve is flattened as the number of prints increases and changes with time. Accordingly, there is a problem in that the sand-blasted developing sleeve will gradually convey less developer and formed images will be thinner gradually. Thus, the sand-blasted developing sleeve has a durability issue. Although it is possible to provide a developing sleeve made of a super-hard stainless steel or to treat the surface of a sleeve to be hard, it is undesirable as the cost increases.

Also, regarding toners, a pulverized toner is broader in its grain size distribution and has more fine powder than a polymer toner. Thus, the pulverized toner is likely to stain the surface of a developing sleeve and generate ghost images. On the other hand, it is desired to develop a pulverized toner that has an excellent cost performance, has an excellent lower-temperature fixing property and heat-resistant storage stability from the perspective of cutting costs of the toner, and generates no residual images.

It is also important to improve the thermal efficiency of a fixing unit in use for an image forming apparatus.

The image forming apparatus forms unfixed toner images on a recording medium such as a recording sheet, copier paper, photosensitive paper and dielectric-coated paper by an image transferring method or a direct method in an image forming process such as electrophotographic recording, electrostatic recording, and magnetic recording. As for a fixing apparatus to fix unfixed toner images, a fixing apparatus of contact heating type, such as heating roller, heating film or electromagnetic induction heating type, is widely adopted.

The heating roller type fixing apparatus basically includes a heating and fixing roller that has a heat source such as a halogen lamp inside so as to control temperature to a predetermined level, and a pressure roller pressed thereby, as a pair of rotary rollers. A recording medium is introduced to a contacting section of the pair of rotary rollers, a so-called fixing nip portion, and is conveyed. Unfixed toner images are melted and then fixed with heat and pressure from the fixing roller and pressure roller.

Additionally, the heating film type fixing apparatus supplies heat from a heating body to a recording medium through a film material while closely attaching the recording medium to the heating body fixed and supported by a supporting member through a heat-resistant thin fixing film, and then sliding and shifting the fixing film in relation to the heating body (see, for example, JP-A Nos. 63-313182 and No. 01-263679).

As the heating body, for example, a ceramic heater having a resistive layer on a ceramic substrate such as alumina and aluminum nitride having properties such as heat-resistance and insulation and good thermal conductivity, is applied in the fixing apparatus. Since a thin film of a low heat capacity can be used as the fixing film, this fixing apparatus has a better heat-transfer efficiency than the heating roller type fixing apparatus, thus shortening a warm-up period and thus allowing a quick start and saving of energy.

As the electromagnetic induction heating type fixing apparatus, there is a technique as in, for instance, JP-A No. 08-22206, that Joule heat is generated by the eddy current generated at a magnetic metallic member by an alternating magnetic field, and then a heating body containing a metallic member is heated by electromagnetic induction.

The configuration of the electromagnetic induction heating type fixing apparatus will be explained below.

FIG. 1 is a schematic view, showing a conventional electromagnetic induction heating type fixing apparatus.

As shown in FIG. 1, the conventional fixing apparatus includes a film-internal-surface guide 21 mounted with a heating body 20 that includes an exciting coil unit 18 and a magnetic metallic member 19 as a heating portion, a heat-resistant cylindrical film 17 that surrounds the film-internal-surface guide 21 while in contact with the magnetic metallic member 19, and a pressure roller 22 that is pressed against the film 17 at the magnetic metallic member 19, forms a fixing nip portion N therebetween with the film 17 and also rotates the film 17.

For the film 17, employed is a heat-resistant single-layer film of PTFE, PFA, FEP or the like having a film thickness of 100 μm or less, preferably, between 20 μm and 50 μm, or a complex-layer film in which PTFE, PFA, FEP or the like is coated on the outer surface of a film of polyimide, polyamide-imide, PEEK, PES, PPS or the like.

Additionally, the film-internal-surface guide 21 includes a rigid and heat-resistant member formed of a resin such as PEEK and PPS, and the heating body 20 is inserted roughly at a center in the longitudinal direction of such a film-internal-surface guide 21.

The pressure roller 22 has a core 22a, and also a heat-resistant rubber layer 22b with a good releasing property, such as silicone rubber, that is provided around the core. The roller is arranged so as to press against the magnetic metallic member 19 of the heating body 20 having the film 17 therebetween by adding a predetermined suppress strength with a bearing or a biasing unit (not shown). The pressure roller 22 is then rotated and driven in a counterclockwise direction by a driving unit (not shown).

As the pressure roller 22 is rotated and driven, frictional force is generated between the pressure roller 22 and the film 17, and rotative force is added to the film 17, thus sliding and rotating the film 17 while being attached closely to the magnetic metallic member 19 of the heating body 20.

When the heating body 20 is at a predetermined temperature, a recording medium 11 having unfixed toner images T formed at an image forming portion (not shown) is introduced between the film 17 and the pressure roller 22 at the fixing nip portion N. The recording medium 11 is conveyed to the fixing nip portion N while being sandwiched between the pressure roller 22 and the film 17, so that heat at the magnetic metallic member 19 is added to the recording medium 11 through the film 17, thereby melting and fixing the unfixed toner images T onto the recording medium 11.

Furthermore, at the outlet of the fixing nip portion N, the recording medium 11 that has just passed through, is separated from the surface of the film 17 and is then conveyed to a discharge tray (not shown).

In such an electromagnetic induction heating type fixing apparatus, the metallic member 19 as an induction heating unit can be arranged near the toner images T on the recording medium 11 through the film 17 by utilizing the generation of an eddy current, and the apparatus has a better heating efficiency than the heating film type fixing apparatus.

In recent years, image forming apparatuses being demanded to be even faster. While a time for heating toner during a fixing period is being shortened, full-color image forming apparatuses in particular are required to have an ability to sufficiently heat and melt thick toner images of four or more laminated layers in a short period.

However, in order to sufficiently surround toner images for even heating and melting, it will be necessary to provide a rubber elastic layer having a certain thickness on the surface of a film so as to maintain a nip width. Due to the low thermal conductivity of the elastic layer, thermal responsiveness becomes poor, which limits image formation at high speed and the saving of energy in the electromagnetic induction heating system. Additionally, JP-A Nos. 2005-173445 and 2005-173446 disclose image forming apparatuses in which a fixing roller having an elastic layer and a pressure roller having an elastic layer form a nip portion through a fixing belt, and a nip width is kept even with the thin fixing belt by heating the fixing belt with a heating roller that is heated by electromagnetic induction, thereby satisfying both high-speed image formation and also the saving of energy.

However, since the fixing belt having a small thermal capacity is used in the image forming apparatus, a belt temperature rapidly decreases and fixing properties cannot be sufficiently maintained if images with a large toner amount are formed, and a particular problem called cold offset occurs.

On the other hand, regarding toners, a method, for example, is known that controls the thermal characteristics of a resin itself, such as glass transition temperature (Tg) and a softening temperature (T½) of a toner binder, so as to improve the fixing properties of toner.

However, lowering Tg in the resin causes the deterioration of heat resistant storage stability. Also, when the softening temperature (T½) decreases due to low-molecular-weight resin or the like, problems such as hot-offset will be found. Thus, a toner with a good lower-temperature fixing property, heat resistant storage stability, and hot-offset resistance cannot be obtained just by controlling the thermal characteristics of resin itself.

In response to a reduced lower-temperature fixing property, there has been an attempt to use a polyester resin having an excellent lower-temperature fixing property and relatively good heat resistant storage stability, instead of conventionally heavily-used styrene-acrylic resin (see JP-A Nos. 60-90344, 64-15755, 02-82267, 03-229264, 03-41470 and 11-305486).

Also proposed is adding a specific non-olefin crystalline polymer having sharp-melting characteristics at a glass transition temperature, in a binder in order to improve a lower-temperature fixing property (JP-A No. 62-63940). However, this proposal is not optimal to molecular structures and molecular mass.

Additionally, JP-B No. 2931899 and JP-A No. 2001-222138 disclose a technique to improve a fixing property by using, for the toner, a crystalline polyester that has sharp-melting characteristics like the above-described specific non-olefin crystalline polymer.

However, the toner in which the crystalline polyester is used as described in JP-B No. 2931899, has a low acid value and hydroxyl value at 5 mgKOH/g or less and at 20 mgKOH/g or less, respectively, and an affinity between paper and the crystalline polyester is low, so that the toner does not have a sufficient lower-temperature fixing property.

Moreover, the toner in which the crystalline polyester is used as described in JP-A No. 2001-222138, is not optimized for the molecular weight of the toner as a final product and for the existing conditions of the crystalline polyester. Therefore, the toner containing the crystalline polyester described in JP-A No. 2001-222138 does not necessarily achieve an excellent lower-temperature fixing property and heat resistant storage stability that are attributed to the crystalline polyester, when it is used as an actual toner. Also, there is no measurement for hot-offset resistance, so that a temperature width that allows preferable image fixation, may not be maintained.

Moreover, JP-A No. 2004-46095 proposes a technique to provide a crystalline polyester resin and a non-crystalline polyester resin that are incompatible with each other, in a sea-island phase separation structure.

The toner described in JP-A No. 2004-46095 uses three kinds of resins containing a crystalline polyester resin as a resin. However, in the attempt to maintain the sea-island phase separation structure of the crystalline polyester resin in this technique, the dispersion particle size of the crystalline polyester resin becomes so large that heat resistant storage stability becomes troublesome and electrical resistance becomes too low, generating defective transfer during the transfer process and often causing rough final images.

Additionally, JP-A No. 2007-33773 proposes a technique in which the existing conditions of a crystalline polyester resin are controlled by regulating an endothermic amount of a peak appearing on an endothermic side in a DSC curve measured by a differential scanning calorimeter so as to achieve meaningful effects for crystalline polyester resin and to add a lower-temperature fixing property and heat resistant storage stability to a toner. However, in JP-A No. 2007-33773, it is assumed to use a resin having a relatively high softening temperature as a non-crystalline polyester resin, used together with the crystalline polyester resin. Thus, a lower-temperature fixing property relies on the crystalline polyester resin, so that the amount of crystalline polyester resin to be used inevitably increases and the risk of deteriorating heat resistant storage stability becomes high due to the compatibility with the non-crystalline resin.

Also, JP-A No. 2005-338814 proposes an art in which a toner contains a large amount of a crystalline polyester resin. However, since an extremely large amount of the crystalline polyester resin is used in this art, there is a risk of degrading heat resistant storage stability due to compatibility with a non-crystalline resin.

Furthermore, JP-B No. 4118498 proposes a technique in which the peak and half width of a molecular weight distribution of a toner and an amount of chloroform insoluble matter are regulated, and two or more kinds of resins having different softening temperatures are used as binding resins. However, since a crystalline polyester resin is not used in this proposal, a lower-temperature fixing property becomes incomplete, compared with the case where a crystalline polyester resin is used.

Moreover, JP-A No. 2005-181848 proposes a toner that includes a binding resin containing a non-crystalline resin and a crystalline resin and copolymer particles in which a radical polymerizable monomer and a sulfonic acid monomer are polymerized, and that is excellent in lower-temperature fixing property, offset resistance, and blocking resistance. This toner has finer copolymer particles so as to increase the scattering thereof, but the particles have a low compatibility with the binding resin and sharp-melting characteristics decrease because of the copolymer particles.

Moreover, JP-A No. 2011-123352 describes that the toner including a binding resin that contains a composite resin with a condensation resin component and a styrene type resin component and a non-crystalline resin, has an excellent charging stability. However, since the toner does not contain a crystalline polyester, sharp-melting characteristics are insignificant.

As described above, there have been various attempts to improve the lower-temperature fixing property of toner. However, there is currently no such toner that is fixable by the fixing apparatus described in JP-A Nos. 2005-173445 and 2005-173446 and has sharp-melting characteristics, and good heat resistant storage stability and hot-offset resistance.

### SUMMARY OF THE INVENTION

It is an object of the present invention to provide a toner for forming an image and an image forming method that provide an excellent lower-temperature fixing property and high hot-offset resistance as well as good storage stability, that develop with a stable toner amount without being affected by the toner consumption history of a preceding image, and that can provide a uniform image with excellent color reproducibility over a long period and can form images of high quality for a long time.

Means to solve the aforementioned problems are as follows. Specifically, the toner of the present invention includes at least a crystalline resin, a non-crystalline resin, and a composite resin.

The crystalline resin is a crystalline polyester resin (A).

The non-crystalline resin includes a non-crystalline resin (B) containing chloroform insoluble matter, and a non-crystalline resin (C) having a softening temperature (T½) that is lower than that of the non-crystalline resin (B) by 25° C. or more.

An absolute value |Tgc−Tgb| of a difference between a glass transition temperature (Tgc) of the non-crystalline resin (C) and a glass transition temperature (Tgb) of the non-crystalline resin (B) is 10° C. or lower.

The composite resin is a composite resin (D) containing a condensation polymerization resin unit and an addition polymerization resin unit.

A molecular weight distribution of the toner has a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the toner.

According to the present invention, the conventional problems can be solved, and a toner for forming an image can be provided that provides an excellent lower-temperature fixing property, high hot-offset resistance as well as good storage stability, develops with a stable toner amount without being affected by the toner consumption history of a preceding image, can provide a uniform image with an excellent color reproducibility over a long period and can form images of high quality for a long time.

### BRIEF DESCRIPTION OF THE DRAWINGS

FIG. 1 is a schematic view, showing a conventional electromagnetic induction heating type fixing apparatus.

FIG. 2 is a schematic view, showing one example of a fixing apparatus used in the present invention.

FIG. 3A is a schematic view, showing one example of an exciting coil arrangement.

FIG. 3B is a schematic view, showing another example of an exciting coil arrangement.

FIG. 4 is a graph, showing the X-ray diffraction results of a crystalline polyester resin a6 used in the example.

FIG. 5 is a graph, showing the X-ray diffraction results of a toner 35 obtained in the example.

FIG. 6 is a schematic view, showing one example of a developing apparatus used in the present invention.

FIG. 7 is a schematic view, showing another example of a developing apparatus used in the present invention.

FIG. 8 is a schematic view, showing one example of an image forming apparatus having the developing apparatus of FIG. 7.

FIG. 9 is a schematic view, showing another example of an image forming apparatus used in the present invention.

FIG. 10 is a schematic view, showing one example of a process cartridge used in the present invention.

FIG. 11 is a schematic view, showing a vertical bar chart that is used to evaluate ghost images, where the arrow indicates a direction in which a paper sheet is fed.

### DETAILED DESCRIPTION OF THE INVENTION

### (Toner)

The toner of the present invention contains at least a crystalline resin, a non-crystalline resin, and a composite resin, and furthermore other components if necessary.

The toner having a lower-temperature fixing property to save energy has a reduced lower limit temperature for fixing, so that heat accumulates in the toner by agitating a developer and the toner components are likely to generally melt out in the two-component developing system. Thus, toner components are likely to adhere to the grooves or the like of the developing sleeve, and problems such as ghost images are found.

In order to achieve both a lower-temperature fixing property and prevention of ghost images, there should be corrective measures taken in both toner and processes.

There has been a demand for toners used in fixing apparatuses to have a lower-temperature fixing property.

The lower temperature fixability of a toner is obtained simply with a toner binder having a lower softening temperature (T½). However, when the softening temperature is lowered, its glass transition temperature also drops, thus degrading heat resistant storage stability.

Additionally, both the lower limit (lower limit fixing temperature) and upper limit (upper limit fixing temperature) of fixable temperatures that do not disturb image quality, decrease, thus limiting hot-offset resistance and also decreasing heat resistant storage stability.

Therefore, it has been a difficult challenge for the designers of toners for electrophotographic imaging formation to achieve a lower-temperature fixing property and heat resistant storage stability as well as hot-offset resistance.

The inventors, after extensive research into the proposition mentioned above, have found that high-quality images having superior hot-offset resistance and with no smears caused by defective fixing, can be formed while saving energy of a fixing apparatus, by providing a toner that has a toner binder containing a crystalline resin, a non-crystalline resin and a composite resin. The crystalline resin is a crystalline polyester resin (A). The non-crystalline resin includes a non-crystalline resin (B) containing chloroform insoluble matter, and a non-crystalline resin (C) having a softening temperature (T½) that is lower than that of the non-crystalline resin (B) by 25° C. or more. An absolute value |Tgc−Tgb| of a difference between a glass transition temperature (Tgc) of the non-crystalline resin (C) and a glass transition temperature (Tgb) of the non-crystalline resin (B) is 10° C. or lower. The composite resin is a composite resin (D) having a condensation polymerization resin unit and an addition polymerization resin unit. A molecular weight distribution of the toner has a main peak between 1,000 and 10,000 based on the gel permeation chromatography (GPC) of a tetrahydrofuran (THF) insoluble matter, and the half width of the molecular weight distribution is 15,000 or less.

The toner binder used in the present invention will be explained herein.

The toner binder can add a lower-temperature fixing property and heat resistant storage stability to the toner since the toner binder has the crystalline polyester resin (A), whose crystalline quality can provide sharp-melting characteristics.

However, when the crystalline polyester resin (A) is used alone as the toner binder, hot-offset resistance becomes extremely poor, so that a fixing temperature range becomes extremely narrow and the toner binder becomes impractical.

Hot-offset resistance can improve and a fixable temperature range can be extended by adding, along with the crystalline polyester resin (A), the non-crystalline resin (B) containing chloroform insoluble matter.

However, when only the crystalline polyester resin (A) and the non-crystalline resin (B) are used, the crystalline polyester resin (A) becomes less effective and its lower-temperature fixing property decreases with more non-crystalline resin (B). On the contrary, with more crystalline polyester resin (A), the crystalline polyester resin (A) becomes compatible with the non-crystalline resin (B) components, other than the chloroform insoluble matter, when melting and kneading are performed thereto, so that heat resistant storage stability remarkably deteriorates due to a lower glass transition temperature of the non-crystalline resin (B).

After extensive research, the inventors found there was no mixing ratio, in the case of adding only the crystalline polyester resin (A) and the non-crystalline resin (B), that can save energy when used in the fixing apparatus and can satisfy all of the lower-temperature fixing property, heat resistance storage stability, and hot-offset resistance even if changes were made to the allocation of the crystalline polyester resin (A) and the non-crystalline resin (B) in the toner.

Then, it was found that the hot-offset resistance property of the non-crystalline resin (B) is not prohibited by adding the non-crystalline resin (C) having a softening temperature (T½) lower than that of the non-crystalline resin (B) by 25° C. or more, so as to lower the allocation of the crystalline polyester resin (A), to prevent the decrease in the glass transition temperature due to the compatibility between the crystalline polyester resin (A) and the non-crystalline resin (B) components, other than the chloroform insoluble matter, and then to supplement the lower-temperature fixing property of the crystalline polyester resin (A) with the non-crystalline resin (C).

However, even when the non-crystalline resin (C) is used in addition to the crystalline polyester resin (A) and the non-crystalline resin (B), heat resistance storage stability cannot be satisfied. Specifically, even when the compatibility between the crystalline polyester resin (A) and the non-crystalline resin (B) components, other than the chloroform insoluble matter, is restrained and the decrease in the glass transition temperature of the toner binder is prevented, interface between the crystalline polyester resin (A) and the non-crystalline resin (B) is likely to be fractured during a grinding process when the crystalline polyester resin (A) is kept in a large dispersion particle size. As a result, the crystalline polyester resin (A) is likely to appear on the surface of toner particles.

Since the crystalline polyester resin (A) is a sharp melt material, it provides excellent heat resistant storage stability when being included inside toner particles. However, when the resin exists on the surface of toner particles, crystals slightly crumble even at the glass transition temperature of the toner binder or lower, so that the crystalline polyester resin (A) functions as a binder among toner particles and consequently deteriorates heat resistant storage stability of a toner. This phenomenon is clearly found particularly in crystalline polyester resins having a low crystallinity.

Additionally, when the compatibility between the crystalline polyester resin (A) and the non-crystalline resin (B) components, other than the chloroform insoluble matter, is restrained by adding the non-crystalline resin (C), shear can hardly work on the toner materials, containing the non-crystalline resin (C), since the non-crystalline resin (C) has a low viscosity during melting and kneading, so that the dispersion particle size of the crystalline polyester resin (A) tends to become large.

The crystalline polyester resin (A) has a relatively low electric resistance, and other toner materials such as a coloring agent, a releasing agent and a resistance regulator cannot get into the domain of the crystalline polyester resin (A). Thus, the other materials stay in the non-crystalline resin (B) and the non-crystalline resin (C) in a relatively high concentration. When the dispersion particle size of the crystalline polyester resin (A) becomes large, toner particles become uneven and furthermore the particles of the crystalline polyester resin (A) are unevenly distributed either to the non-crystalline resin (B) or to the non-crystalline resin (C). Therefore, it will be difficult to control toner characteristics such as electric resistance.

As the composite resin (D) having a condensation type resin unit and an addition condensation type resin unit is added, the dispersion of the crystalline polyester resin (A) improves since the composite resin (D) is harder than the non-crystalline resin (C) and an adequate kneading pressure (shear) is added during a melting and kneading process. Also, as an absolute value |Tgc−Tgb| of a difference between a glass transition temperature (Tgc) of the non-crystalline resin (C) and a glass transition temperature (Tgb) of the non-crystalline resin (B) is 10° C. or lower, the glass transition of the non-crystalline resin (C) and the non-crystalline resin (B) in the toner materials occurs almost simultaneously during a cooling period after the melting and kneading process of the toner materials. Therefore, fine particle dispersion can be kept without unevenly distributing the crystalline polyester resin (A) to either resin, thus preventing unevenness, allowing easy control over toner characteristics such as prohibiting the decline in electric resistance and the like.

In addition, since the composite resin (D) is hard and is likely to appear on an interface during a grinding process, the non-crystalline resin (C) having a low softening temperature is unlikely to appear on the surface of toner particles, contributing to improving heat resistant storage stability.

Also, since the surface of toner particles becomes harder by adding the composite resin (D), the deterioration of toner due to physical stress is prevented. In the case of adding external additives, such as charging additives and fluidity additives, the external additives are prevented from being buried in toner particles. Toner characteristics such as charging characteristics due to stress become stable, and stable image qualities can be provided over a long period of time.

The toner binder of the present invention can achieve a lower-temperature fixing property, heat resistant storage stability, and hot-offset resistance as the crystalline polyester resin (A), the non-crystalline resin (B), the non-crystalline resin (C), and the composite resin (D) supplement each other as described above. The toner is required to have a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the toner.

Particularly, when a distance between the molecules of the chloroform insoluble matter in the non-crystalline resin (B) is short and the molecular weight distribution of the toner binder as a whole becomes broad, the lower-temperature fixing property may decrease due to the non-crystalline resin (C) having a low softening temperature.

Subsequently, each resin in the toner binder will be explained.

### <<Crystalline Polyester Resin (A)>>

There is no particular limitation on the crystalline polyester resin (A) described above, and any conventionally known resins may be used. However, there is an advantage in that, by using a linear unsaturated aliphatic dicarboxylic acid for its acid component, a crystal structure is more easily formed than in the case of using an aromatic dicarboxylic acid, and that the crystalline polyester resin (A) can be more effectively functional.

The crystalline polyester resins (A) may be manufactured by a polycondensation reaction between, for example, (i) a polycarboxylic acid component including a linear unsaturated aliphatic dicarboxylic acid or its reactive derivative (such as acid anhydride, lower alkyl ester having a carbon atoms of 1 to 4, and acid halide) and (ii) a polyhydric alcohol component including linear aliphatic diol. The resin (A) preferably includes an ester bond represented by the following general formula (A) in the backbone thereof.

[—OCO—R—COO—(CH₂)n-] General Formula (A)

wherein R represents a linear unsaturated aliphatic dicarboxylic acid residue having 2 to 20 carbon atoms; and n is an integer from 2 to 20.

Whether or not the formula (A) structure is present can be determined by using solid C¹³ NMR.

Examples of the linear unsaturated aliphatic group include linear unsaturated aliphatic groups derived from linear unsaturated dicarboxylic acids such as maleic acid, fumaric acid, 1,3-n-propene-dicarboxylic acid, and 1,4-n-butenedicarboxylic acid.

In formula (A) mentioned above, the unit “(CH₂)ₙ” represents a linear aliphatic dihydric alcohol residue. In this case, specific examples of a linear aliphatic dihydric alcohol residue include the group derived from linear aliphatic dihydric alcohols, such as ethyleneglycol, 1,3-propylene glycol, 1,4-butane diol, and 1,6-hexanediol.

In addition to the polycarboxylic acid component, other polycarboxylic acids may be added in a small amount if required.

Examples of such other polycarboxylic acids include (i) branched unsaturated aliphatic dicarboxylic acids, (ii) saturated aliphatic polycarboxylic acids such as saturated aliphatic dicarboxylic acids and saturated aliphatic tricarboxylic acids; and (iii) aromatic polycarboxylic acids such as aromatic dicarboxylic acids and aromatic tricarboxylic acids. For instance, included are dicarboxylic acids such as malonic acid, succinic acid, glutaric acid, adipic acid, suberic acid, sebacic acid, citraconic acid, phthalic acid, isophthalic acid and, terephthalic acid; tri- or more-carboxylic acids such as trimellitic anhydride, 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylenecarboxypropane, and 1,2,7,8-octanetetracarboxylic acid.

The additive amount of these polycarboxylic acids is not particularly limited and may be appropriately selected depending on the purpose, but the amount is preferably 30% or less by mole, more preferably 10% or less by mole, relative to the total amount of the carboxylic acid component.

In addition to the polyhydric alcohol component mentioned above, other polyhydric alcohol components may be added if necessary. Other polyhydric alcohol components include, for example, branched aliphatic dihydric alcohols, cyclic dihydric alcohols, and tri- or more-hydric alcohols. For example, included are 1,4-bis(hydroxymethyl)cyclohexane, polyethylene glycol, ethylene oxide adducts of bisphenol A, propylene oxide adducts of bisphenol A, and glycerin.

The additive amount of these polyhydric alcohols is not particularly limited and any amount may be appropriately selected depending on the purpose. However, the amount is preferably 30% or less by mole, more preferably, 10% or less by mole, relative to the total amount of alcohol. The polyhydric alcohol is appropriately added in such an amount that the resultant polyester resin has crystallinity.

The crystalline polyester resins (A) preferably have a sharp molecular weight distribution to impart a good lower-temperature fixing property.

In the molecular weight distribution chart in which the logarithmic molecular weights (M: molecular weights) are plotted on the horizontal axis and mass percentages are plotted on the vertical axis, it is preferable that crystalline polyester resins (A) have a molecular weight peak in a range from 3.5% by mass to 4.0% by mass and the peak has a half width of 1.5 or less.

It is preferable that the molecular weight of the crystalline polyester resin (A) is relatively low. In the molecular weight distribution obtained by subjecting an o-dichlorobenzene insoluble matter to gel permeation chromatography (GPC), the weight-average molecular weight (Mw) of the resin (A) is preferably from 5,500 to 6,500; the number average molecular weight (Mn) thereof is preferably from 1,300 to 1,500; and the ratio (Mw/Mn) is preferably from 2 to 5.

The gel permeation chromatography (GPC) is measured as follows.

A column is stabilized in a heat chamber at 40° C. As a solvent, tetrahydrofuran (THF) is streamed into the column at this temperature at a flow velocity of 1 mL per minute, and a THF sample solution of a resin in which a sample concentration is adjusted to 0.05% by mass to 0.6% by mass, is injected at 50 μL to 200 μL for measurement.

In order to measure the molecular weight of the sample (toner), the molecular weight distribution of the sample was calculated from the correlation between the logarithmic values and number of counts of the standard curve that was prepared from the standard samples of various monodisperse polystyrenes.

As the standard polystyrene samples used for the standard curve, it is appropriate to use ones with a molecular weight of 6×10², 2.1×10³, 4×10³, 1.75×10⁴, 5.1×10⁴, 1.1×10⁵, 3.9×10⁵, 8.6×10⁵, 2×10⁶ and 4.48×10⁶ produced by, for instance, Pressure Chemical Co. or Sysmex Corporation, and to use at least about ten standard polystyrene samples. An RI (refractive index) detector can be used as a detector therefor.

It is preferable that the glass transition temperature (Tg) and the softening temperature (T½) of the crystalline polyester resins (A) are low, within a range of maintaining good high temperature storage stability of toner.

The glass transition temperature (Tg) of the crystalline polyester resin (A) is not particularly limited and any temperature may be appropriately selected depending on the purpose. However, the glass transition temperature is preferably from 80° C. to 130° C., more preferably, from 80° C. to 125° C.

The softening temperature (T½) of the crystalline polyester resin (A) is not particularly limited and any temperature may be appropriately selected depending on the purpose. However, the softening temperature is preferably from 80° C. to 130° C., more preferably, from 80° C. to 125° C.

When the glass transition temperature (Tg) and the softening temperature (T½) are higher than the above-described range, the lower limit temperature for fixing toner rises, and a lower-temperature fixing property may deteriorate.

The softening temperature (T½) of the crystalline polyester resin (A) can be measured using the elevated type Flow Tester CFT-500 (manufactured by Shimadzu Corporation), from a temperature that is equivalent to half of the temperature between a flow starting point and a flow ending point when the samples of 1 cm² are molten and outflown with the conditions of a die hole diameter of 1 mm, a load of 20 kg/cm² and a rate of temperature increase of 6° C./min.

Additionally, the method of measuring the glass transition temperature Tg of the crystalline polyester resin (A) will be explained below.

The crystallinity of a polyester resin can be determined by whether or not an X-ray diffraction pattern from a powder X-ray diffraction apparatus has a peak.

The crystalline polyester resin (A) preferably has, in its diffraction pattern, at least one diffraction peak in a (2θ) angle range from 19° to 25°, more preferably, in each (2θ) angle range (i) from 19° to 20°, (ii) from 21° to 22°, (iii) from 23° to 25°, and (iv) from 29° to 31°.

This indicates that there are diffraction peaks in a (2θ) angle range from 19° to 25°, in other words, that the crystalline polyester resin (A) has kept its crystallinity even after the toner is formed, so that the crystalline polyester resin (A) can clearly exhibit its function.

The powder X-ray diffraction analysis was performed by using an instrument RINT1100 from Rigaku Corp. The measurement was carried out by using a wide angle goniometer with a Cu tube under the conditions of 50 kV-30 mA in a tube voltage-current.

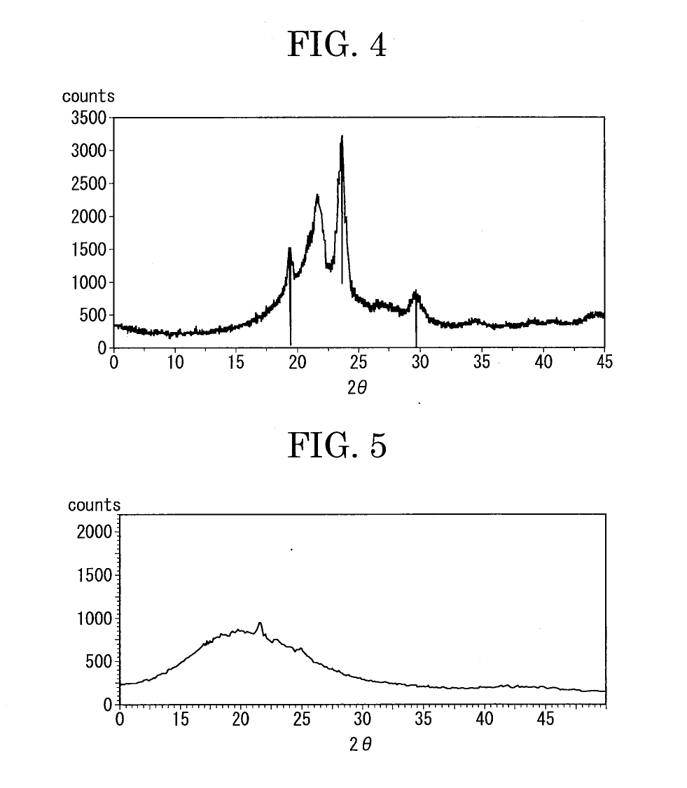

FIG. 4 illustrates the X-ray diffraction results of a crystalline polyester resin a6 used in an example described below, and FIG. 5 illustrates the X-ray diffraction results of a toner 35 obtained in an example described below.

### <Non-Crystalline Resin>

The non-crystalline resin used in the present invention includes a non-crystalline resin (B) containing chloroform insoluble matter, and a non-crystalline resin (C) having a softening temperature (T½) that is lower than that of the non-crystalline resin (B) by 25° C. or more. An absolute value |Tgc−Tgb| of a difference between a glass transition temperature (Tgc) of the non-crystalline resin (C) and a glass transition temperature (Tgb) of the non-crystalline resin (B) is 10° C. or lower.

Because of the non-crystalline resin, both offset resistance and lower-temperature fixing property are satisfied; the glass transition of the non-crystalline resin (C) and that of the non-crystalline resin (B) occur almost simultaneously; and the particles of the crystalline polyester resin (A) can be dispersed finely and evenly. Also, as the glass transition temperature of the non-crystalline resin (B) is set closer to the glass transition temperature, effective for the lower limit for fixing, of the non-crystalline resin (C), the lower-temperature fixing property improves further.

When an absolute value |Tgc−Tgb| of a difference between the glass transition temperature (Tgc) of the non-crystalline resin (C) and the glass transition temperature (Tgb) of the non-crystalline resin (B) is 10° C. or lower, the crystalline polyester resin (A) can be finely dispersed preventing unevenness and improving sharp-melting characteristics as well as low-temperature fixing property. When the absolute value |Tgc−Tgb| is higher than 10° C., the non-crystalline resin (C) and the non-crystalline resin (B) cool off differently in the toner during a kneading and cooling process, and the crystalline polyester resin (A) starts coagulating, thus deteriorating heat resistance storage stability and lowering electric resistance.

Conventionally known materials may be used for the non-crystalline resin (B) and the non-crystalline resin (C) as long as the content of chloroform insoluble matter, the magnitude relationship of softening temperatures between the non-crystalline resin (B) and the non-crystalline resin (C), and a range of the absolute value |Tgc−Tgb| of a difference in glass transition temperatures are satisfied.

The non-crystalline resin is not particularly limited and any resin may be appropriately selected depending on the purpose. Examples of the non-crystalline resin include oil-based resins such as polystyrene, chloropolystyrene, poly-α-methylstyrene, styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-acrylic ester copolymer (e.g. styrene-methyl acrylate copolymer, styrene-ethyl acrylate copolymer, styrene-butyl acrylate copolymer, styrene-octyle acrylate copolymer, and styrene-phenyl acrylate copolymer), styrene-methacrylate copolymer (e.g. styrene-methyl methacrylate copolymer, styrene-ethyl methacrylate copolymer, styrene-butyl methacrylate copolymer, and styrene-phenyl methacrylate copolymer), styrene-α-methyl chloroacrylate copolymer, styrene-acrylonitrile-acrylate ester copolymer or similar styrene resin (e.g. polymer or copolymer containing styrene or substituted styrene), vinyl chloride resin, styrene-vinyl acetate copolymer, rosin modulated maleate resin, phenol resin, epoxy resin, polyethylene resin, polypropylene resin, ionomer resin, polyurethane resin, silicone resin, ketone resin, ethylene-ethyl acrylate copolymer, and xylene resin, polyvinyl butyral resin, and oil-based resins with added hydrogen. The resins recited herein may be used alone or in combination. Among these resins, polyester resin is preferable in consideration of lower-temperature fixing property.

Also, these non-crystalline resins may be produced through any suitable production technique according to purpose with no particular limitations, including e.g., bulk polymerization, solution polymerization, emulsion polymerization, and suspension polymerization.

The polyester resin is not particularly limited and any resin may be appropriately selected depending on the purpose. The polyester resin may be obtained by the condensation polymerization between alcohol and carboxylic acid.

The alcohol includes, for example, glycols such as ethylene glycol, diethylene glycol, and triethylene glycol, propylene glycol; 1,4-bis(hydroxy methyl)cyclohexane; etherified bisphenols such as bisphenol A; other divalent alcohol monomers, and trivalent or higher polyalcohol monomers.

The carboxylic acid includes, for example, divalent organic acid monomers such as maleic acid, fumaric acid, phthalic acid, isophthalic acid, terephthalic acid, and succinic acid, malonic acid; and tri- or more-carboxylic acid monomers such as 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylene carboxypropane, and 1,2,7,8-octanetetracarboxylic acid.

As long as the non-crystalline resin is a polyester resin, there is no particular limitation and any resin may be appropriately selected depending on the purpose. However, in consideration of heat resistant storage stability, the glass transition temperature Tg is preferably 55° C. or higher, more preferably, between 60° C. and 80° C.

The non-crystalline resin (B) contains chloroform insoluble matter, which increases hot offset resistance.

The content of the chloroform insoluble matter is not particularly limited and may be selected depending on the purpose. However, as it becomes more likely to achieve hot offset resistance, the content is preferably from 5% by mass to 40% by mass.

Moreover, if the content of the chloroform insoluble matter in the toner is from 2% by mass to 20% by mass after the toner is formed, hot offset resistance will be kept and the allocation of resins, other than the non-crystalline resin (B), will be maintained at the same time, which is thus preferable. When the content of the chloroform insoluble matter in the toner is below 2% by mass, hot offset resistance derived from the chloroform insoluble matter becomes weak. At more than 20% by mass, the allocation of a binder resin which contributes to a lower-temperature fixing property relatively decreases, so that the lower-temperature fixing property sometimes deteriorates.

The chloroform insoluble matter can be measured as follows.

About 1.0 g of a toner (or a binder resin) is weighed, and about 50 g of chloroform is added thereto. Fully dissolved solution is separated by centrifugal separation, and is filtered at a normal temperature with a qualitative filter of JIS P3801 No. 5C. Filter residue is insoluble, and the content of the chloroform insoluble matter is expressed in a ratio (% by mass) between a toner amount and a filter residue amount.

Moreover, in the case of measuring the chloroform insoluble matter in the toner, about 1.0 g of the toner is weighed, and the same method as for the binder resin is used. However, there is a solid such as a pigment in the filter residue, and thermal analysis may also be applied for the measurement.

### <<Non-Crystalline Resin (C)>>

The non-crystalline resin (C) supplements the lower-temperature fixing property of the crystalline polyester resin (A), and contributes to the lower-temperature fixing property.

It is preferable that the non-crystalline resin (C) has the softening temperature (T½) that is lower than that of the non-crystalline resin (B) by 25° C. or more, more preferably, by between 35° C. and 50° C.

The non-crystalline resin (C) has a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the non-crystalline resin (C).

The non-crystalline resin (C) has an extremely good lower-temperature fixing property, so that the resin can supplement the lower-temperature fixing property sufficiently even if less crystalline polyester resin (A) is added to the toner.

Paradoxically, even if the non-crystalline resin (C) having the above-described molecular weight distribution is used, the proportion of the non-crystalline resin (C) is higher in comparison with other binder resins contained in the toner as long as the toner has a main peak between 1,000 and 10,000 in its molecular weight distribution and has the half width of 15,000 or less.

### <<Composite Resin (D)>>

The composite resin (D) is a resin in which a condensation polymerization monomer and an addition polymerization monomer are chemically bonded to each other (also sometimes mentioned as “hybrid resin” hereinafter). The resin can improve the dispersibility of the crystalline polyester resin (A) and other toner materials, and prevent the materials from being non-uniformly dispersed in toner particles.

Since the condensation polymerization monomer and the addition polymerization monomer are chemically bonded to each other in the composite resin (D), a portion derived from the condensation polymerization monomer and a portion derived from the addition polymerization monomer are evenly dispersed. Thus, the glass transition temperature Tg of the composite resin (D) is not divided into the glass transition temperature Tg of the portion derived from the condensation polymerization monomer component and the glass transition temperature Tg of the portion derived from the addition polymerization monomer, and the composite resin (D) has sharp-melting characteristics.

The composite resin (D) is obtained by subjecting, to a mixture of the condensation polymerization monomer and the addition polymerization monomer as materials, condensation polymerization reaction and addition polymerization reaction simultaneously and concurrently, or condensation polymerization reaction and addition polymerization reaction or addition polymerization reaction and condensation polymerization reaction sequentially in the same reaction container.

Examples of the condensation polymerization monomer in the composite resin (D) include a polyhydric alcohol and polycarboxylic acid forming a polyester resin unit; a polycarboxylic acid and amine or an amino acid forming a polyamide resin unit or a polyester-polyamide resin unit. However, when the composite resin includes a condensation polymerization resin unit of polyester and an addition polymerization unit of vinyl resin, it has a good affinity to a polyester resin and has excellent dispersibility in toner particles. Thus, the composite resin (D) can be even more effectively functional and thus be preferable.

For the polyhydric alcohol, dihydric alcohols, and trivalent or higher polyhydric alcohols may be used.

Examples of the dihydric alcohols include 1,2-propanediol, 1,3-propanediol, ethylene glycol, propylene glycol, 1,3-butandiol, 1,4-butandiol, 2,3-butandiol, diethylene glycol, triethylene glycol, 1,5-pentanediol, 1,6-hexanediol, neopentylglycol, 2-ethyl-1,3-hexanediol, hydrogenated bisphenol A or diol obtained by polymerizing a cyclic ether such as ethylene oxide or propylene oxide with bisphenol A.

Examples of trivalent or higher polyhydric alcohols include sorbitol, 1,2,3,6-hexanetetrol, 1,4-sorbitan, pentaerythritol, dipentaerythritol, tripentaerythritol, 1,2,4-butanetriol, 1,2,5-pentatriol, glycerol, 2-methylpropanetriol, 2-methyl-1,2,4-butanetriol, trimethylolethane, trimethylolpropane, and 1,3,5-trihydroxybenzene.

Of these, hydrogenated bisphenol A or alcohol components having bisphenol A skeleton such as diol obtained by polymerizing a cyclic ether such as ethylene oxide or propylene oxide with bisphenol A can be preferably used because they add heat resistance storage stability and mechanical strength to resins.

For the polycarboxylic acid, dicarboxylic acids and tri- or more-carboxylic acids may be used.

Examples of the dicarboxylic acids include benzenedicarboxylic acids such as phthalic acid, and isophthalic acid, terephthalic acid, or the anhydrides thereof; alkyldicarboxylic acids such as succinic acid, adipic acid, and sebacic acid, azelaic acid, or the anhydrides thereof; unsaturated dibasic acids such as maleic acid, citraconic acid, itaconic acid, alkenyl succinic acid, fumaric acid, and mesaconic acid; and unsaturated dibasic acid anhydrides such as maleic acid anhydride, citraconic acid anhydride, and itaconic acid anhydride, alkenyl succinic acid anhydride.

Examples of the tri- or more-carboxylic acids include trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, tetra(methylenecarboxy)methane, 1,2,7,8-octanetetracarboxylic acid and Empol trimer acid; or the anhydrides thereof and partially lower alkylesters of these compounds.

Of these, aromatic polycarboxylic acid compounds such as phthalic acid, isophthalic acid, terephthalic acid, and trimellitic acid are preferable in consideration of heat resistance storage stability and mechanical strength of resins.

The amine components or amino acid components include, for example, diamine (B1), trivalent or higher polyamine (B2), amino alcohol (B3), amino mercaptan (B4), amino acid (B5), and blocked products (B6) in which amino groups of the B1 to B5 are blocked.

The diamine (B1) includes, for example, aromatic diamine (phenylene diamine, diethyl toluene diamine, 4,4′-diaminodiphenyl methane, etc.), alicyclic diamine(4,4′-diamino-3,3′-dimethyl dicyclohexyl methane, diamine cyclohexane, and isophorone diamine, etc.), aliphatic diamine (ethylene diamine, tetramethylene diamine, hexamethylene diamine, etc.).

The trivalent or higher polyamine (B2) includes, for example, diethylene triamine and triethylene tetramine.

The amino-alcohol (B3) includes, for example, ethanolamine and hydroxyethylaniline.

The amino mercaptan (B4) includes, for example, aminoethyl mercaptan and aminopropyl mercaptan.

Examples of the amino acids (B5) include amino propionic acid, amino caproic acid, and ∈-caprolactam.

Blocked products (B6) of the (B1) to (B5) amino groups include, for example, ketimine compounds obtained from any one of amines and ketones of the (B1) to (B5) (acetone, methyl ethyl ketone, methyl isobutyl ketone and others), and oxazolidine compounds.

The molar ratio of the condensation polymerization monomer component in the composite resin (D) is not particularly limited and may be suitably selected depending on the purpose. However, the molar ratio is preferably 5% by mol to 40% by mol, more preferably, 10% by mol to 25% by mol.

When the molar ratio is less than 5% by mol, the dispersibility of the composite resin with the polyester resin degrades. When the ratio is more than 50% by mol, the dispersibility of a releasing agent tends to degrade.

When the condensation polymerization reaction is carried out, an esterified catalyst, etc., may be used.

The addition polymerization monomer in the composite resin (D) is not particularly limited and may be suitably selected on the basis of the purpose; however, a vinyl monomer is a typical choice.

Examples of the vinyl monomer include styrene vinyl monomers such as styrene, o-methylstyrene, m-methylstyrene, p-methylstyrene, p-phenylstyrene, p-ethylstyrene, 2,4-dimethylstyrene, p-n-amylstyrene, p-tert-butylstyrene, p-n-hexylstyrene, p-n-4-dichlorostyrene, m-nitrostyrene, o-nitrostyrene, and p-nitrostyrene; acrylic acid, methyl acrylate, ethyl acrylate, propyl acrylate, n-butyl acrylate, isobutyl acrylate, n-octyl acrylate; methacrylate vinyl monomers such as methacrylic acid, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethylaminoethyl methacrylate, and diethylaminoethyl methacrylate; and other vinyl monomers or other monomers forming a copolymer.

Examples of the above-described other vinyl monomers or other monomers forming a copolymer include monoolefins such as ethylene, propylene, butylene, and isobutylene; polyenes such as butadiene and isoprene; vinyl halides such as vinyl chloride, vinylidene chloride, vinyl bromide, and vinyl fluoride; vinyl esters such as vinyl acetate, vinyl propionate, and vinyl benzoate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinyl pyrrole, N-vinyl carbazole, N-vinyl indole, and N-vinyl pyrrolidone; vinylnaphthalines; acrylic acid or methacrylic acid derivatives such as acrylonitrile, methacrylonitrile, and acrylamide; unsaturated dibasic acids such as maleic acid, citraconic acid, itaconic acid, alkenyl succinic acid, fumaric acid, and mesaconic acid; unsaturated dibasic acid anhydrides such as maleic anhydride, citraconic anhydride, itaconic anhydride and, alkenyl succinic anhydride; monoesters of unsaturated dibasic acids such as maleic acid monomethyl ester, maleic acid monoethyl ester, maleic acid monobutyl ester, citraconic acid monomethyl ester, citraconic acid monoethyl ester, citraconic acid monobutyl ester, itaconic acid monomethyl ester, alkenyl succinic acid monoethyl ester, fumaric acid monomethyl ester, and mesaconic acid monomethyl ester; unsaturated dibasic acid esters such as dimethyl maleic acid and dimethyl fumaric acid; α,β-unsaturated acids such as crotonic acid and cinnamic acid; α,β-unsaturated acid anhydrides such as crotonic acid anhydride and cinnamic acid anhydride; monomers containing a carboxyl group such as an anhydride between the α,β-unsaturated acid and a lower fatty acid, alkenyl malonic acid, alkenyl glutaric acid, alkenyl adipic acid, and the acid anhydrides thereof or the monoesters thereof, acrylic or methacrylic acid hydroxyalkyl esters such as 2-hydroxyethyl acrylate, 2-hydroxyethyl methacrylate, and 2-hydroxypropyl methacrylate; and monomers containing a hydroxy group such as 4-(1-hydroxy-1-methylbutyl)styrene and 4-(1-hydroxy-1-methylhexyl)styrene.

Of these monomers, styrene, acrylic acid, n-butyl acrylate, 2-ethylhexyl acrylate, methacrylic acid, n-butyl methacrylate, 2-ethylhexyl methacrylate, etc., are preferably used. It is particularly preferable to use at least styrene and acrylic acid in combination because the use of the combination significantly improves the dispersibility of releasing agents.

Further, if necessary, a crosslinker for the addition polymerization monomer can be added. As the crosslinker, the following crosslinkers are included.

Examples of aromatic divinyl compounds include divinyl benzene and divinyl naphthalene.

As diacrylate compounds bonded with an alkyl chain, there are, for example, ethylene glycol diacrylate, 1,3-butylene glycol diacrylate, 1,4-butadiol diacrylate, 1,5-pentandiol diacrylate, 1,6-hexanediol diacrylate, neopentyl glycol diacrylate, and diacrylate compounds in which the acrylate of these compounds is substituted with methacrylate.

As diacrylate compounds bonded with an alkyl chain containing an ether bond, there are, for example, diethylene glycol diacrylate, triethylene glycol diacrylate, tetraethylene glycol diacrylate, polyethylene glycol #400 diacrylate, polyethylene glycol #600 diacrylate, dipropylene glycol diacrylate, and diacrylate compounds in which the acrylate of these compounds is substituted with methacrylate.

Besides the diacrylate compounds, included are diacrylate compounds and dimethacrylate compounds each of which is bonded with a chain containing an aromatic group and an ether bond, etc.

As polyester diacrylates, for example, trade name MANDA (produced by Nippon Kayaku Co., Ltd.) is exemplified.

As polyfunctional crosslinkers, included are, for example, pentaerythritol triacrylate; trimethylolethane triacrylate; trimethylolpropane triacrylate; tetramethylolmethane tetraacrylate and oligoester acrylate; or polyfunctional crosslinkers in which the acrylate of these compounds is substituted with methacrylate; triallyl cyanurate; and triallyl trimellitate.

The additive amount of the crosslinker is not particularly limited and may be suitably selected depending on the purpose. However, relative to 100 parts by mass of the addition polymerization monomer, the additive amount is preferably 0.01 parts by mass to 10 parts by mass, more preferably, 0.03 parts by mass to 5 parts by mass.

A polymerization initiator to be used during the polymerization of the addition polymerization monomer is not particularly limited and may be suitably selected depending on the purpose. Examples thereof include azo polymerization initiators such as 2,2′-azobis-isobutylonitrile, 2,2′-azobis(4-methoxy-2,4-dimethylvaleronitrile), and 2,2′-azobis(2,4-dimethylvaleronitrile); and peroxide polymerization initiators such as methylethylketone peroxide, acetyl acetone peroxide, 2,2-bis(tert-butylperoxy)butane, tert-butylhydroperoxide, benzoyl peroxide, and n-butyl-4,4-di-(tert-butylperoxy)valerate.

Two or more of these polymerization initiators may be mixed for use so as to adjust the molecular weight and molecular weight distribution of the resins.

The additive amount of the polymerization initiator is not particularly limited and any amount may be appropriately selected depending on the purpose. Relative to 100 parts by mass of the addition polymerization monomer, the additive amount is preferably 0.01 parts by mass to 15 parts by mass, more preferably, 0.1 parts by mass to 10 parts by mass.

In order to chemically bond the condensation polymerization resin unit with the addition polymerization resin unit, a monomer that is reactive to both condensation polymerization and addition polymerization, for example, is used.

As such a bireactive monomer, examples are unsaturated carboxylic acids such as acrylic acid and methacrylic acid; unsaturated dicarboxylic acids such as fumaric acid, maleic acid, and citraconic acid, itaconic acid or the anhydrides thereof; and vinyl monomers containing a hydroxy group.

The additive amount of the bireactive monomer is not particularly limited and any amount may be appropriately selected depending on the purpose. Relative to 100 parts by mass of the addition polymerization monomer, the additive amount is preferably 1 part by mass to 25 parts by mass, more preferably, 2 parts by mass to 20 parts by mass.

The composite resin (D) can promote and/or complete both the condensation polymerization reaction and the addition polymerization reaction at the same time, or also independently complete each reaction by selecting reaction temperatures and reaction periods respectively as long as these reactions are carried out in the same reaction container.

For example, there is a method in which, in a reaction container, a mixture of an addition polymerization monomer and a polymerization initiator is dropped into a mixture composed of a condensation polymerization monomer and then mixed. Subsequently, addition polymerization is first completed by radical polymerization reaction, and then condensation polymerization reaction is carried out by raising the reaction temperature.

As described above, two types of resin units can be effectively dispersed and bonded to each other by promoting two independent reactions in the same reaction container.

There is no particular limitation on the softening temperature (T½) of the composite resin (D), and the temperature may be appropriately selected depending on the purpose. However, the softening temperature is preferably between 90° C. and 130° C., more preferably, between 100° C. and 120° C.

When the softening temperature (T½) is below 90° C., heat resistant storage stability as well as offset resistance sometimes degrades. Above 130° C., the lower-temperature fixing property sometimes degrades.

The glass transition temperature of the composite resin (D) is not particularly limited and any temperature may be appropriately selected depending on the purpose. However, in consideration of fixing property, storage stability, and durability, the glass transition temperature is preferably 45° C. to 80° C., more preferably, 50° C. to 70° C., and further more preferably, 53° C. to 65° C.

The acid value of the composite resin (D) is not particularly limited and any value may be appropriately selected depending on the purpose. However, the acid value is preferably 5 mgKOH/g to 80 mgKOH/g, more preferably, 15 mgKOH/g to 40 mgKOH/g, from the perspective of chargeability and environmental safety.

The toner binder is a combination of the crystalline polyester resin (A), the non-crystalline resin (B), the non-crystalline resin (C), and the composite resin (D). The toner binder containing these resins is the most well-balanced resin when the proportion of the non-crystalline resin (B) is higher relative to the other resins. There are no adverse effects from excess crystalline polyester resin or tetrahydrofuran (THF) insoluble matter, or no clear negative effect on lower limit for fixing resulting from the hardness of the composite resin (D). Each resin functions effectively. Lower-temperature fixing property, heat resistance storage stability and hot offset resistance become preferable.

Thus, the content of the crystalline polyester resin (A) in the toner binder is not particularly limited and any content may be appropriately selected depending on the purpose. However, the content is preferably 1% by mass to 15% by mass, more preferably, 1% by mass to 10% by mass.

The content of the non-crystalline resin (B) is not particularly limited and any content may be appropriately selected depending on the purpose. However, the content is preferably 10% by mass to 40% by mass.

The content of the non-crystalline resin (C) is not particularly limited and any content may be appropriately selected depending on the purpose. However, the content is preferably 50% by mass to 90% by mass.

The content of the composite resin (D) is not particularly limited and any content may be appropriately selected depending on the purpose. However, the content is preferably 3% by mass to 20% by mass.

### <Other Components>

There is no particular limitation on other components and any component may be appropriately selected depending on the purpose. Examples of the components include colorants, releasing agents, charge controlling agents, and fatty acid compounds.

### —Colorant—

There is no particular limitation on the colorant, and any known dyes and pigments may be appropriately selected depending on the purpose. The examples thereof include Carbon Black, Lamp Black, Iron Black, Aniline Blue, Phthalocyanine Blue, Phthalocyanine Green, Hansa Yellow G, Rhodamine 6C Lake, Calco oil Blue, Chrome Yellow, Quinacridone, Benzidine Yellow, Rose Bengal, and triarylmethane dyes. The resins recited herein may be used alone or in combination.

Color of the colorant is not particularly limited and may be suitably selected depending on the purpose. For example, black colorants and color colorants are exemplified. These colorants may be used as a black toner or as a full color toner.

Carbon Black has a preferable black coloring power. However, it is also a preferable conductive material, so that when the used amount thereof is large or when it is contained in toner particles in a coagulated manner, an electric resistance decreases, which causes poor transfer during a transfer process.

Particularly, when Carbon Black is used with the crystalline polyester resin (A), the Carbon Black particles cannot get into the domain of the crystalline polyester resin. Thus, Carbon Black stays in the resins, other than the crystalline polyester resin (A), in a relatively high concentration when the crystalline polyester resin is contained in the toner in a large dispersion particle size. As a result, the Carbon Black particles are likely to be enclosed in toner particles as an aggregate, and electric resistance is likely to decrease excessively.

As Carbon Black is used together with the composite resin (D), it is preferably dispersed and the above-described risks may be reduced in the present invention. Additionally, when Carbon Black is included, the viscosity of molten toner can increase at the time of fixing the toner to a recording medium. Thus, such effect as restraining the hot offset caused by the decrease in viscosity can also be found when the non-crystalline resin (C) is added in a large amount.

The content of the colorant in the toner is not particularly limited and may be suitably selected depending on the purpose. However, relative to the toner resin components, the content is preferably 1% by mass to 30% by mass, more preferably 3% by mass to 20% by mass.

### —Releasing Agent—

There is no particular limitation on the releasing agent and the agent may be appropriately selected depending on the purpose. The examples thereof include low molecular weight polyolefin waxes such as low molecular weight polyethylene and low molecular weight polypropylene; synthesized hydrocarbon waxes such as Fischer Tropsch waxes; natural waxes such as beeswaxes, carnauba waxes, candelilla waxes, rice waxes, and montan waxes; petroleum waxes such as paraffin waxes and microcrystalline waxes; higher fatty acids such as stearic acid, palmitic acid, and myristic acid and metal salts of higher fatty acid; higher fatty acid amide; synthesized ester waxes; and modified versions of these waxes. The resins recited herein may be used alone or in combination.

Among these releasing agents, carnauba waxes, modified carnauba waxes, polyethylene waxes, and synthesize ester waxes are preferably used.

The carnauba waxes are extremely useful because these waxes can be relatively finely dispersed in polyester resins or polyol resins, so that a good combination of hot offset resistance, transferability and durability can be easily imparted to the toner. When the releasing agents are used along with fatty acid amide compounds, the effect of staying on the surface of fixed images increases significantly, thereby further improving smear resistance.

There is no particular limitation on the content of the releasing agent and the content may be appropriately selected depending on the purpose. Relative to the toner, the content is preferably from 2% by mass to 15% by mass. When the content is less than 2% by mass, the effect of preventing hot offset becomes incomplete. Above 15% by mass, transferability and durability sometimes decrease.

There is no particular limitation on the melting point of the releasing agent, and any melting point may be appropriately selected depending on the purpose. However, the melting point is preferably 70° C. to 150° C. When the melting point is below 70° C., the heat resistant storage stability of the toner often decreases. Above 150° C., the releasing property sometimes becomes incomplete.

### —Charge Controlling Agent—

There are no particular limitations on the charge controlling agent and any agent may be appropriately selected depending on the purpose. Examples include nigrosine and denatured products by fatty acid metal salt, etc.; onium salts such as phosphonium salt or the lake pigments thereof; triphenylmethane dyes or the lake pigments thereof; higher fatty acid metal salts; diorganotin oxides such as dibutyltin oxide, dioctyltin oxide, and dicyclohexyltin oxide; diorganotin borates such as dibutyltin borate, dioctyltin borate, and dicyclohexyltin borate; organic metal complexes; chelate compounds; monoazo metal complexes; acetylacetone metal complexes; aromatic hydroxycarboxylic acid; aromatic dicarboxylic acid metal complexes; quaternary ammonium salts; metal salicylate compounds; aromatic hydroxycarboxylic acids; aromatic mono- and poly-carboxylic acids, or the metal salts thereof; anhydrides; esters; and phenol derivatives such as bisphenol. The resins recited herein may be used alone or in combination.

The content of the charge controlling agent is not particularly limited and the content may be appropriately selected depending on the purpose. Relative to 100 parts by mass of toner resin components, the content is preferably 0.1 parts by mass to 10 parts by mass, more preferably, 1 part by mass to 5 parts by mass.

When a metal salicylate compound is selected out of these charge controlling agents, hot offset resistance can improve simultaneously, which is preferable. Particularly, a complex having a trivalent or higher valent metal that can occupy 6 coordination positions, reacts to sections that are highly reactive to resins and waxes, thus forming a slightly bridged structure. Thus, the agent is effective for hot offset resistance. Also, as the agent is used along with the composite resin (D), dispersibility improves and charging polarity can be controlled more effectively.

The trivalent or higher valent metals include, for example, Al, Fe, Cr, and Zr.

A compound expressed by the following Formula A can be used as the metal salicylate compound. As a metal complex having M as zinc, Bontron E-84 manufactured by Orient Chemical Industries Co., Ltd. may be included.

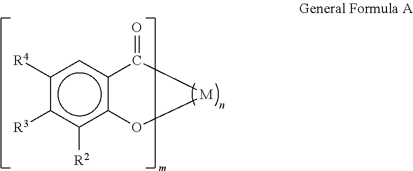

wherein R², R³, and R⁴ are independently selected from a hydrogen atom, a straight-chain or branched-chain alkyl group having 1 to 10 carbon atoms, and a straight-chain or branched-chain alkenyl group having 2 to 10 carbon atoms; M represents chrome, zinc, calcium, zirconium, or aluminum; m represents an integer of 2 or above; and n represents an integer of 1 or above.

### —Fatty Acid Amides—

It is preferable that the toner of the present invention contains a fatty acid amide compound.

When the fatty acid amide compound is added, along with a crystalline polyester resin, to a pulverized toner processed by melting and kneading during a toner manufacturing process, the crystalline polyester resin that was molten during the kneading process, starts recrystallizing further in the kneaded material during the cooling process of the crystalline polyester resin. Accordingly, the resin's compatibility with other resins decreases, preventing the glass transition temperature of the toner from decreasing and thus improving heat resistance storage stability. When the compound is used with a releasing agent, it becomes possible to keep the agent on the surface of fixed images, thereby increasing durability against friction and thus improving smear resistance.

There is no particular limitation on the content of the fatty acid amide compound in the toner, and any content may be appropriately selected depending on the purpose. However, the content is preferably 0.5% by mass to 10% by mass.

For the fatty acid amide compound, a compound expressed by the following general formula (I) or alkylenebisfatty acid amides may be used. Among them, alkylenebisfatty acid amides are preferable.

R¹—CO—NR²R³ General Formula (I)

wherein R¹ represents an aliphatic hydrocarbon group having 10 to 30 carbon atoms, and each of R² and R³ represents a hydrogen atom, an alkyl group having 1 to 10 carbon atoms, an aryl group having 6 to 10 carbon atoms, or an aralkyl group having 7 to 10 carbon atoms.

The alkyl group, aryl group, and aralkyl group for use as the groups R² and R³ may be substituted with an inert substituent, such as a fluorine atom, chlorine atom, cyano group, alkoxyl group, and alkylthio group, and is more preferably nonsubstituent.

Examples of such compounds expressed by the formula (I) mentioned above include stearic acid amide, stearic acid methylamide, stearic acid diethylamide, stearic acid benzylamide, stearic acid phenylamide, behenamide, behenic acid dimethylamide, myristamide, and palmitamide.

The alkylenebisfatty acid amides are preferably the compounds expressed by the following general formula (II).

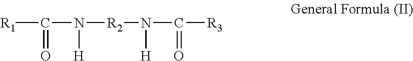

wherein each of R₁ and R₃ represents an alkyl group having 5 to 21 carbon atoms, or an alkenyl group having 5 to 21 carbon atoms; and R₂ represents an alkylene group having 1 to 20 carbon atoms.

Examples of the alkylenebis-saturated-fatty acid amides expressed by formula (II) include methylenebisstearamide, ethylenebisstearamide, methylenebispalmitamide, ethylenebispalmitamide, methylenebisbehenamide, ethylenebisbehenamide, hexamethylenebisstearamide, hexaethylenebispalmitamide, and hexamethylenebisbehenamide. The resins recited herein may be used alone or in combination. Among these materials, ethylenebisstearamide is particularly preferable.

When the fatty acid amide compound has a softening temperature (T½) lower than the surface temperature of a fixing member during a fixing process, the compound can produce a good releasing effect as a releasing agent at the surface of the fixing member.

Other alkylenebisfatty acid amides in use for the present invention include alkylenebis-saturated-fatty acid amides and mono- or bi-valent alkylenebis-unsaturated-fatty acid amides, such as propylenebisstearamide, butylenebisstearamide, methylenebisoleamide, ethylenebisoleamide, propylenebisoleamide, butylenebisoleamide, methylenebislauramide, ethylenebislauramide, propylenebislauramide, butylenebislauramide, methylenebismyristamide, ethylenebismyristamide, propylenebismyristamide, butylenebismyristamide, propylenebispalmitamide, butylenebispalmitamide, methylenebispalmitoleamide, ethylenebispalmitoleamide, propylenebispalmitoleamide, butylenebispalmitoleamide, methylenebisarachamide, ethylenebisarachamide, propylenebisarachamide, butylenebisarachamide, methylenebiseicosenamide, ethylenebiseicosenamide, propylenebiseicosenamide, butylenebiseicosenamide, methylenebisbeheamide, ethylenebisbeheamide, propylenebisbehenamide, butylenebisbehenamide, methylenebiserucamide, ethylenebiserucamide, propylenebiserucamide, and butylenebiserucamide. The amides recited herein may be used alone or in combination.

There is no limitation on the toner of the present invention and any toner may be appropriately selected depending on the purpose. However, the toner preferably has an endothermic peak, which is derived from the crystalline polyester resin (A), within a range from 90° C. to 130° C. on the basis of the endothermic peak measurement of the toner by differential scanning calorimetry (DSC). When the endothermic peak, derived from the crystalline polyester resin (A), is in the range from 90° C. to 130° C., the crystalline polyester resin does not melt at a normal temperature. Also, the toner melts in a range of relatively low fixing temperatures and can be fixed to a recording medium. Thus, heat resistant storage stability and lower-temperature fixing property can be achieved more effectively.

There is no particular limitation on the toner, and any toner may be appropriately selected depending on the purpose. However, the endothermic amount at the endothermic peak is preferably between 1 J/g and 15 J/g.

When the amount is below 1 J/g, there is too little effective crystalline polyester resin in toner particles and the crystalline polyester resin cannot function sufficiently. Above 15 J/g, there is too much effective crystalline polyester resin in toner particles and the absolute endothermic amount of the resin that is compatible with the non-crystalline polyester resins increases, thus lowering the glass transition temperature of the toner and often causing the decrease in heat resistant storage stability.

For the DSC measurement (endothermic peak, glass transition temperature Tg), a differential scanning calorimeter (“DSC-60” manufactured by Shimadzu Corporation) is used while the temperature is raised from 20° C. to 150° C. at 10° C./minute.

The endothermic peak deriving from the crystalline polyester is around 80° C. to 130° C. that is the melting point of crystalline polyester, and the endothermic amount can be determined from an area that is surrounded by a baseline and an endothermic curve. Generally, the endothermic amount is often measured by raising temperatures twice in DSC measurement. However, in the present invention, an endothermic peak and a glass transition temperature may be measured on the basis of an endothermic curve from the first heatup period.

When the endothermic peak deriving from the crystalline polyester resin (A) overlaps with the endothermic peak of a wax, the endothermic amount of the wax is deducted from the endothermic amount at the overlapping peak. The endothermic amount of the wax can be calculated from the endothermic amount of the wax by itself and the content of the wax in the toner.

There is no particular limitation on the particle diameter of the toner of the present invention and any diameter may be appropriately selected depending on the purpose. In order to obtain a high-quality image excellent in thin line reproducibility, etc., a volume average particle diameter is preferably 4 μm to 10 μm.

When the volume average particle diameter is smaller than 4 μm, there will be a problem in cleaning during a development process and transfer efficiencies during a transfer process, thus deteriorating image quality. When the volume average particle diameter is larger than 10 μm, the thin line reproducibility of images may deteriorate.

There is no particular limitation on the measuring of the volume average particle diameter of the toner and this may be appropriately selected depending on the purpose herein. For example, Coulter Counter TAII manufactured by Coulter Electronics, Inc. in the USA may be used.

The toner of the present invention is preferably a pulverized toner that is produced by the so-called grinding technique including at least a melting and kneading process in the production process.

The grinding technique mentioned above is a method for providing a pulverized toner, from mixing toner materials containing at least the crystalline polyester resin (A), the non-crystalline resin (B), the non-crystalline resin (C), the composite resin (D), the colorant, and the releasing agent, by dry blending; melting and kneading by a kneading machine; and then grinding.

First, the toner materials are mixed and then placed in a melting and kneading machine for processing. Examples of the melting and kneading machine include a monoaxial or a biaxial continuous-type kneader and a batch-type kneader equipped with a roll mill. Specifically, preferably used are a KTK-type biaxial extruder manufactured by Kobe Steel Ltd., a TEM-type extruder manufactured by Toshiba Machine Co. Ltd., a biaxial extruder manufactured by KCK Co., Ltd., a PCM-type biaxial extruder manufactured by Ikegai Corp., and a co-kneader manufactured by Buss AG.

It is preferable that the melting and kneading are operated under appropriate conditions that will not cause cutoff of molecular chains in a binding resin. To be more specific, a melting and kneading temperature is set by referring to the softening point of a binder resin. When the temperature is much higher than the softening point, the molecular chains may be severely cut off. When the temperature is much lower, no dispersion may proceed.

In the grinding process, a kneaded product obtained by the kneading is ground. In the grinding, it is preferable that the kneaded product is first crudely ground and then finely ground. In this case, preferably used is a method in which the product is ground by collision with a collision board in a jet stream, ground by allowing particles to collide together in the jet stream, or ground at a narrow gap between a mechanically rotating rotor and a stator.

In the classification process mentioned above, the ground product produced in the grinding process is classified and then adjusted to a predetermined particle diameter. The classification can be carried out by removing fine particle portions with the use of a cyclone, a decanter, a centrifugal separation or the like.

After completion of the grinding and classification, the ground product is classified in an air current by centrifugal force or the like, thus producing a toner with a predetermined particle diameter.

The toner of the present invention is a pulverized toner prepared through a melting and kneading process in a production process. When the kneaded product is to have a thickness of 2.5 mm or more at a cooling process after the melting and kneading process of raw materials, a cooling speed of a kneaded product slows down, and a period of recrystallizing the crystalline polyester resin (A) that is molten in the kneaded product, becomes long. Consequently, recrystallization accelerates, and the function of the crystalline polyester resin (A) can be more effective. Although recrystallization is also effectively accelerated by means of mixing a fatty acid amide as described above, the same effect can also be obtained by adjusting the production process as just described. There is no particular limitation on the thickness of the kneaded product, and there is no upper limit thereof. However, when the thickness is more than 8 mm, efficiency decreases sharply in the grounding process, so that the thickness is preferably at 8 mm or less.

The inorganic fine particles such as a hydrophobic silica fine powder may also be added to the toner base particles produced as described above in order to increase the fluidity, storage stability, developability, and transferability of the toner.

A typical powder mixer is used to mix such additives, but it is preferable to carry a jacket or the like in order to control inner temperature. The additives may be added, for instance, gradually or in the middle of the mixing process to change the history of the load added to the additives.

The number of rotations, rotation speed, mixing period, and temperature of the mixer may be properly changed. Additionally, a large load may be initially applied to the additive, and subsequently a relatively small load may be applied thereto, or vice versa.

Examples of the mixers that may be used for mixing external additives, include a V-type Mixer, Rocking Mixer, Lodige Mixer, Nauta Mixer, and Henschel Mixer. After the mixing process, the mixture may be passed through a sieve of 250 meshes or above so as to remove coarse particles and aggregated particles.

### <Developer>

When the toner of the present invention is used as a developer, it may be used either as a one-component developer configured solely by a toner or as a two-component developer mixed with a carrier, and there is no particular limitation on a developer. However, when the toner is used in a high-speed printer, etc. that develops in response to recent faster information processing speeds, the two-component development method, in which a magnet is included inside as magnetic field generating unit and a magnetic brush is formed on a developing sleeve, is applied. Accordingly, even if the surface roughness of the developing sleeve is made smaller, a developer can be conveyed. In consideration of preventing the developing sleeve from being contaminated, of improving charging ability and of extending service life, it is preferable to use the developer as a two-component developer.

### —Carrier—

There is no particular limitation on the carrier, and any carrier can be appropriately selected depending on the purpose. It is, however, preferable that the carrier has a core and a resin layer covering the core.

There is no particular limitation on the material of the core, and any material can be appropriately selected from the known materials. Examples preferably include a manganese strontium (Mn—Sr) based material and manganese magnesium (Mn—Mg) based material with 50 emu/g to 90 emu/g. In terms of securing the image density, preferable are highly magnetized materials such as iron powder (100 emu/g or more) and magnetite (75 emu/g to 120 emu/g). In terms of being advantageous in attaining high quality image by weakening the collision of toner against an electrostatic latent image bearing member at which the toner is raised, preferable are weakly magnetized materials such as copper-zinc (Cu—Zn) based material (30 emu/g to 80 emu/g). They may be used alone or in combination of two or more.

There is no particular limitation on the particle diameter of the core, and any particle diameter can be appropriately selected depending on the purpose. In terms of average particle diameter (volume average particle diameter (D₅₀)), preferable is 10 μm to 200 μm and more preferable is 40 μm to 100 μm. When the average particle diameter (volume average particle diameter (D₅₀)) is less than 10 μm, there may be more fine powder in the distribution of carrier particles, thus lowering magnetization per particle and often causing carrier particle scattering. When the average particle diameter exceeds 200 μm, the specific surface area decreases, often causing toner scattering and poorly reproducing particularly solid parts in full color printing with more solid parts.

There is no particular limitation on the material of the resin layer, and any resin can be appropriately selected from the known resins depending on the purpose. The resin includes, for example, amino resin, polyvinyl resin, polystyrene resin, halogenated olefin resin, polyester resin, polycarbonate resin, polyethylene resin, polyvinyl fluoride resin, polyvinylidene fluoride resin, polytrifluoroethylene resin, poly hexafluoropropylene resin, copolymer of vinylidene fluoride with acryl monomer, copolymer of vinylidene fluoride with vinyl fluoride, fluoro terpolymers (fluorinated tri(multi) copolymers) such as terpolymers of tetrafluoro ethylene, vinylidene fluoride, and a non-fluorinated monomer, and silicone resin. The resins recited herein may be used alone or in combination of two or more. Of these resins, silicone resin is particularly preferable.

There is no particular limitation on the silicone resin, and any silicone resin can be appropriately selected from generally known silicone resins depending on the purpose. The silicon resin includes, for example, straight silicone resin of only an organosiloxane bond; and silicone resin modified with alkyd resin, polyester resin, epoxy resin, acryl resin, or urethane resin.

The silicone resin may include a commercially available product. The straight silicone resin includes, for example, KR271, KR255, and KR152 made by Shin-Etsu Chemical Co., Ltd., and SR2400, SR2406, and SR2410 made by Dow Corning Toray Co., Ltd.

As the modified silicone resin, commercially available products can be used. Included are, for example, KR206 (alkyd-modified), KR5208 (acryl-modified), ES1001N (epoxy-modified), and KR305 (urethane-modified) made by Shin-Etsu Chemical Co., Ltd.; and SR2115 (epoxy-modified) and SR2110 (alkyd-modified) made by Dow Corning Toray Co., Ltd.

It is noted that the silicone resin can be used solely but can also be used together with a component which undergoes a crosslinking reaction or a charge-regulating component.

The resin layer may include a conductive powder and others if necessary. The conductive powder includes, for example, metal powder, carbon black, titanium oxide, tin oxide, and zinc oxide. The average particle diameter of the conductive layer is preferably 1 μm or less. When the average particle diameter of the conductive powder exceeds 1 μm, it may be difficult to control the electric resistance.

The resin layer can be formed by procedures in which, for example, the silicone resin or the like is dissolved in a solvent to prepare a coating solution; thereafter, the coating solution is coated uniformly on the surface of the core by a known coating method, and the resultant is dried and printed. The coating method includes, for example, a dipping method, spray method, and brush coating method.

There is no particular limitation on the solvent, and any solvent can be appropriately selected depending on the purpose. The solvent includes, for example, toluene, xylene, methyl ethyl ketone, methyl isobutyl ketone, cellosolve, and butyl acetate.

There is no particular limitation on the printing, and printing by external heating or by internal heating may be applied. The printing can be conducted, for example, by a method of using a stationary-type electric furnace, a fluid-type electric furnace, a rotary-type electric furnace, a burner or the like, or by a method of using a microwave.

The content of the carrier in the resin layer is preferably 0.01% by mass to 5.0% by mass. When the content is less than 0.01% by mass, it may be impossible to form the resin layer uniformly on the surface of the core. When the content exceeds 5.0% by mass, the resin layer may become excessively thick to granulate between carriers, thus failing to obtain uniform carrier particles.

When the developer is a two-component developer, there is no particular limitation on the content of the carrier in the two-component developer, and any content can be appropriately selected depending on the purpose. The content is preferably, for example, 90% by mass to 98% by mass, and more preferably 93% by mass to 97% by mass.

Generally, the ratio of mixing a toner with a carrier in the two component developer is preferably 1 part by mass to 10.0 parts by mass relative to 100 parts by mass of the carrier.

### (Image Forming Method and Image Forming Apparatus)

The image forming method according to the present invention includes at least electrostatic latent image forming, developing, transferring, and fixing, and further includes other processes selected appropriately in accordance with the intended use such as charge-eliminating, cleaning, recycling, and controlling.

The image forming apparatus used in the present invention includes an electrostatic latent image bearing member, an electrostatic latent image forming unit, a developing unit, a transfer unit, and a fixing unit, and further includes other units selected appropriately by necessity, such as a charge-eliminating unit, a cleaning unit, a recycling unit, and a control unit.

The image forming method of the present invention may be preferably carried out with the image forming apparatus used in the present invention. The electrostatic latent image forming process can be carried out by the electrostatic latent image forming unit; the developing process can be carried out by the developing unit; the transferring process can be carried out by the transfer unit; the fixing process can be carried out by the fixing unit; and the other processes can be carried out by the other units.

The electrostatic latent image forming process is a process of forming an electrostatic latent image on an electrostatic latent image bearing member.

The electrostatic latent image bearing member (which may be referred to as an “electrophotographic photoconductor”, “photoconductor” or “image bearing member” hereinafter) is not particularly limited in terms of the material, shape, structure, size and the like thereof, and any of the mentioned may be appropriately selected from those known in the art. The electrostatic latent image bearing member preferably has a drum-like shape, and the examples of the materials thereof include inorganic photoconductors such as amorphous silicones and seleniums; and organic photoconductors such as polysilanes and phthalo polymethines. Among these materials, amorphous silicones or the like are preferred in terms of longer operating life.

An electrostatic latent image can be formed by, for instance, charging the surface of the electrostatic latent image bearing member uniformly and then exposing imagewise by means of the electrostatic latent image forming unit. The electrostatic latent image forming unit includes, for example, a charger for charging the surface of the electrostatic latent image bearing member uniformly and an exposer for exposing the surface of the electrostatic latent image bearing member imagewise.

The charging can be performed by applying electric voltage to the surface of the electrostatic latent image bearing member using, for example, the charger.

The charger is not particularly limited and this may be selected appropriately depending on the purpose. Examples of the charger include contact type chargers known in the art equipped with a conductive or semi-conductive roller, a brush, a film, a rubber blade or the like, and noncontact-type chargers which utilize corona discharge such as corotron and scorotron.

The exposures can be performed by exposing the surface of the electrostatic latent image bearing member imagewise by using, for example, the exposer.

The exposer is not particularly limited and this may be appropriately selected based on the purpose as long as the exposures can be formed imagewise on the surface of the electrostatic latent image bearing member charged by the charger. For example, there are various types of exposers such as photocopy optical systems, rod lens array systems, laser beam systems, and liquid-crystal shutter optical systems.

In the present invention, an optical rear system may be employed, in which exposures are performed imagewise from the back side of the electrostatic latent image bearing member.

### —Developing Process and Developing Unit—

The developing process is a process of developing the electrostatic latent image using the toner and the developer of the present invention to form the image into a visible image.

The visible image can be formed by developing the electrostatic latent image using, for example, the toner and the developer of the present invention, and also using the developing unit.

There is no particular limitation on the developing unit as long as an image can be developed by using, for example, the toner and the developer of the present invention. Any developing unit can be appropriately selected from conventionally known units. Preferable is, for example, a developing device which stores the toner and the developer of the present invention and has at least a developing device capable of imparting the toner and the developer to the electrostatic latent image in contact or non-contact therewith. More preferable is a developing device equipped with a container containing the toner.

The developing device may be a dry-type developing device, a wet-type developing device, a single-color developing device, or a multi-color developing device. Preferable is, for example, a developing device which has an agitator for frictionally agitating the toner and the developer to effect charging, and a rotatable magnet roller.

Inside the developing device, for example, the toner and the carrier are mixed and agitated, and the toner is charged by the resulting friction, and kept raised on the surface of a rotating magnet roller, thereby forming a magnetic brush. Since the magnet roller is arranged in the vicinity of the electrostatic latent image bearing member (photoconductor), the toner constituting the magnetic brush formed on the surface of the magnet roller is partially moved to the surface of the electrostatic latent image bearing member (photoconductor) due to an electrical suction force. As a result, the electrostatic latent image is developed with the toner and a visible image is formed on the surface of the electrostatic latent image bearing member (photoconductor) with the toner.

The developing unit used for the developing process preferably includes a developing sleeve containing a base and a coating layer on the base.

As the developing sleeve has the coating layer, the layer can fill in sleeve grooves that are similar in scale to that of toner particles, thus limiting catch between the developing sleeve and toner particles and the deterioration of the toner. This effect is particularly more obvious in low image area printing with a two-component development type high speed printer.

In the case of using the toner with a volume average particle diameter of 4 μm to 10 μm, when the developing sleeve has a surface roughness (Ra) of 10 μm or below, it becomes possible to prevent toner particles from being caught and also toner from deteriorating. Thus, ghost images can be prevented.

There is no particular limitation on the surface roughness (Ra) of the developing sleeve and any roughness may be appropriately selected depending on the purpose. The surface roughness, however, is preferably 8 μm or less, more preferably, between 0.1 μm and 4 μm. When the surface roughness is below 0.1 μm, the toner is unlikely to be caught, and it is not possible to obtain an effect in accordance with an increase in production cost.

The surface roughness (Ra) is an average value of the measurement, by a surface roughness measuring instrument, at randomly selected predetermined locations (100 locations).

Any covering method can be applied as long as the developing sleeve is covered and the sleeve grooves are filled out, but is preferably metallic spraying.

There is no particular limitation on the base and it may be appropriately selected depending on the purpose. For instance, an aluminum (Al) tube, a stainless steel (SUS) cylinder or the like may be used.

There is no particular limitation on the surface treatment material of the base as long as it is abrasion-resistant, and any material may be appropriately selected depending on the purpose. However, the material preferably contains at least one element selected from groups 2 to 6 and groups 12 to 16 of the periodic table of the elements, more preferably, TiN, MoO₂ and Cr, and most preferably, TiN.

As for an external additive of the toner, the one containing Ti or Si is primarily used. By coating the surface of the developing sleeve with a material containing elements having an electronegativity that is relatively close to that of Ti or Si, electrostatic force decreases between toner particles and the developing sleeve, thus preventing toner from sticking.

A developer to be stored in the developing device is the one containing the toner of the present invention. The developer may be a one-component developer or a two-component developer.

### —Transferring Process and Transfer Unit—

The transferring process is a process of transferring a visible image to a recording medium. A preferable aspect is that, by using an intermediate transfer member, a visible image is preliminarily transferred onto the intermediate transfer member and then the visible image is secondarily transferred onto the recording medium. A more preferable aspect is that the transferring includes a primary transferring process of transferring a visible image onto the intermediate transfer member by using two or more colors as a toner, preferably, by using a full-color toner to form a composite transfer image, and a secondary transferring process of transferring the composite transfer image onto the recording medium.

The visible images can be transferred by, for example, charging the electrostatic latent image bearing member (photoconductor) by using a transfer charger, and the transferring can be performed by the transfer unit. The transfer unit preferably includes a primary transfer unit configured to transfer a visible image onto an intermediate transfer member so as to form a composite transfer image, and a secondary transfer unit configured to transfer the composite transfer image onto the recording medium.

The intermediate transfer member is not particularly limited and may be selected appropriately from those known in the art depending on the purpose. The examples thereof preferably include an image-transfer belt, and the like.

The transfer units (the primary transfer unit and the secondary transfer unit) preferably includes at least a transfer device for separating and then charging the visible image that is formed on the electrostatic latent image bearing member (photoconductor), onto the recording medium. The transfer unit may be single, or two or more.

Examples of the transfer device include a corona transfer device with corona discharge, a transfer belt, a transfer roller, a pressure transfer roller, and an adhesive transfer device.

There is no particular limitation on the recording medium and any medium may be appropriately selected from recording mediums known in the art (recording paper).

The fixing process is a process of fixing a visible image transferred onto a recording medium by using an image fixing device. The fixing may be performed onto the recording medium separately for each individual color of the toner, or simultaneously in a laminated condition of these colors.

There is no particular limitation on the image fixing device and any device may be appropriately selected depending on the purpose. However, a heat pressure unit known in the art is preferable. Examples of the heat pressure unit include a combination of a heating roller and a pressure roller, and a combination of a heating roller, a pressure roller, and an endless belt.

The heating temperature in the heat pressure unit is preferably 80° C. to 200° C.

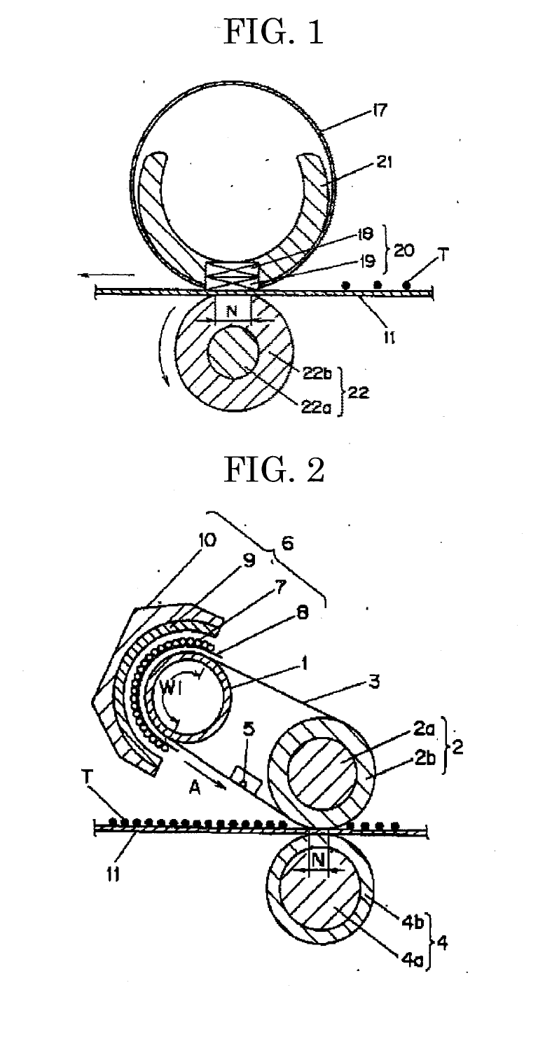

Herein, FIG. 2 is a schematic view, showing one example of a fixing device used in the present invention. In FIG. 2, included are a heating roller 1 heated by a heating unit 6, a fixing roller 2 arranged in parallel with the heating roller 1, an endless heat resistant belt (toner heating medium) 3 that is wound around the heating roller 1 and the fixing roller 2, is heated by the heating roller 1, and rotates in an arrow A direction by the rotation of the roller, and a pressure roller 4 to press against the fixing roller 2 via the belt 3.

Preferably, the heating unit 6 directly generates heat of a heat-generating member such as the heating roller and/or the endless heat resistant belt with electromagnetic induction. Directly generating heat by electromagnetic induction can prevent the members, other than a conductive body, from being heated. Thus, since there is no heating at unnecessary locations, it has a better heat exchange efficiency and can rapidly raise the surface temperature of the fixing roller and the endless heat-resistant belt, to the fixing temperature, using less electric power than a heater lamp type heating method.

The heating roller 1 is configured of a hollow cylindrical magnetic metal member, which is made of, for example, iron, cobalt, nickel, or an alloy of those metals, having e.g., an outside diameter of 20 mm and a wall thickness of 0.1 mm and having high temperature increase rates at a low thermal capacity.

The fixing roller 2 includes, for example, a cored bar 2a made of metal such as stainless steel, and an elastic member 2b that is made of a heat resistant silicone rubber in a solid or foamed state that covers the core bar 2a. In order to form a contacting portion of a predetermined width between the pressure roller 4 and the fixing roller 2 by a pressing force from the pressure roller 4, the outside diameter of the roller is selected to be about 40 mm, larger than that of the heating roller 1. The elastic member 2b has a wall thickness of about 3 mm to 6 mm and its hardness is about 40° to 60° in Asker hardness. With this structure, a thermal capacity of the heating roller 1 is smaller than that of the fixing roller 2. Accordingly, the heating roller 1 is heated at high speed, and hence, a warm-up period is shortened.

The belt 3 stretched between the heating roller 1 and the fixing roller 2 is heated at a contacting region W1 with the heating roller 1 heated by the induction heating unit 6. Additionally, the belt 3 is continuously heated by the rotation of the rollers 1 and 2; as a result, heating is performed over the belt as a whole.

The belt 3 includes a base and a release layer. A thickness of the release layer is preferably from 50 μm to 500 μm, more preferably, 150 μm to 250 μm.

With the release layer, the belt 3 sufficiently covers a toner image T formed on the recording material 11. Accordingly, along with the fixing roller having an elastic layer and the pressure roller having an elastic layer, the toner image T can be uniformly heated and melted.

If the thickness of the release layer is smaller than 50 μm, the thermal capacity of the belt 3 would be small. A belt surface temperature quickly drops in a toner fixing process, and fixing performance cannot be sufficiently secured in some cases.

When the release layer is thicker than 500 μm, the thermal capacity of the belt 3 becomes large and warm-up takes longer. Additionally, the belt surface temperature cannot drop easily in the toner fixing process, and the effect of coagulating molten toner cannot be obtained at the exit of the fixing portion, thereby often causing so-called hot offset in which the toner sticks to the belt due to a decrease in the releasability of the belt.

As for the base, applied are, for instance, heat resistant resins such as fluororesin, polyimide resin, polyamide resin, polyamide-imide resin, PEEK resin, PES resin, and PPS resin. When the base is made of a magnetic metal that is heat-generated by electromagnetic induction, the base becomes a heat-generating layer and generates heat as the belt itself, which is thus preferable.

The pressure roller 4 includes, for instance, a cored bar 4a that is a metallic cylindrical member of high thermal conductivity, such as copper or aluminum, and an elastic member 4b that is provided on the surface of the cored bar 4a and has excellent heat resistance and toner releasability. Stainless steel (SUS), other than the metals mentioned above, may be used for the cored bar 4a.

The pressure roller 4 presses the fixing roller 2 via the belt 3, thereby forming the fixing nip portion N. In the embodiment, the pressure roller 4 is made harder than the fixing roller 2. Accordingly, the pressure roller 4 bites into the fixing roller 2 and the belt 3. Due to this bite, the recording material 11 curves along the circumferentially-shaped surface of the pressure roller 4, allowing the recording material 11 to be released easily from the surface of the belt 3.

The outside diameter of the pressure roller 4 is about 40 mm, equal to that of the fixing roller 2. A wall thickness thereof is about 1 mm to 3 mm, thinner than that of the fixing roller 2. The hardness thereof is about 50° to 70° in Asker hardness, harder than that of the fixing roller 2 as described above.

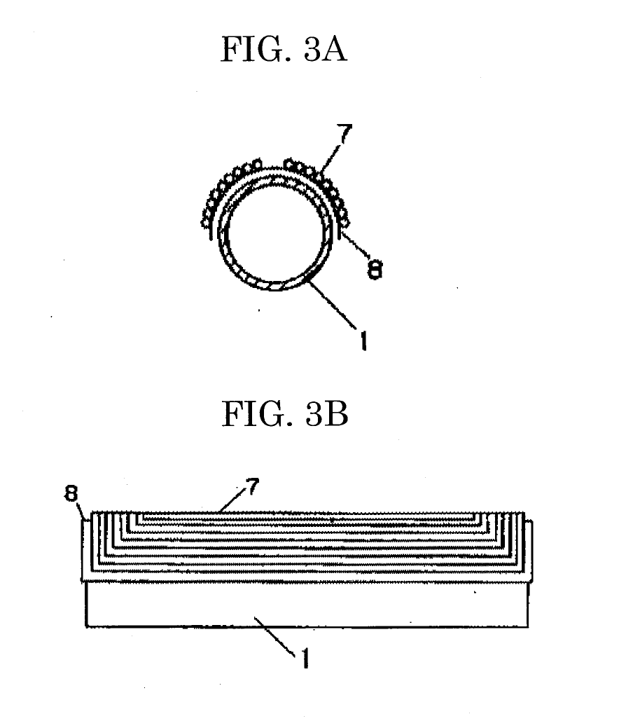

The induction heating unit 6 for heating at least one of the heating roller 1 and the belt 3 with electromagnetic induction, as shown in FIG. 2 and FIGS. 3A and 3B, includes an exciting coil 7 as magnetic field generating unit, and a coil guide plate 8 around which this exciting coil 7 is wound.

The coil guide plate 8 has a semi-cylindrical shape that is arranged in close proximity to the outer circumference of the heating roller 1. As shown in FIG. 3B, the exciting coil 7 is the one in which one long exciting coil wire is wound alternately in an axial direction of the heating roller 1 along this coil guide plate 8.

Further, for the exciting coil 7, an oscillation circuit is connected to a driving power source (not shown) of variable frequencies.

Outside the exciting coil 7, a semi-cylindrical exciting coil core 9 made of a ferromagnetic material such as ferrites is fixed to an exciting coil core support member 10 to be arranged in close proximity to the exciting coil 7. Additionally, in this embodiment, the exciting coil core 9 employs the one having a relative permeability of 2,500.

The exciting coil 7 is fed with a high-frequency AC of 10 kHz to 1 MHz, preferably, a high-frequency AC of 20 kHz to 800 kHz from the driving power source, whereby an alternating magnetic field is generated. Then, this alternating magnetic field acts on the heating roller 1 and/or a heating layer of the belt 3 in a contacting region W1 between the heating roller 1 and the heat-generating resistant belt 3, and in the vicinity thereof. An eddy current flows in a direction to prevent the change of this alternating magnetic field inside thereof.

This eddy current causes Joule heat in response to the resistances of the heating roller 1 and/or the heat-generating layer of the belt 3, and the heating roller 1 and the belt 3 having the heat-generating layer are heated by electromagnetic induction mainly in the contacting region between the heating roller 1 and the belt 3 and in the vicinity thereof.

In the belt 3 heated in such a manner, temperatures at a belt inner surface are detected by temperature detection unit 5 made of a temperature sensing element having a high thermal responsiveness, such as a thermistor disposed in contact with the inner surface side of the belt 3 in the vicinity of the inlet side of the fixing nip portion N.

The charge eliminating process is a process of applying a charge eliminating bias to the electrostatic latent image bearing member so as to eliminate charges. This is suitably performed by a charge eliminating unit.

The charge eliminating unit is not particularly limited as long as it is capable of applying a charge eliminating bias to the electrostatic latent image bearing member, and can be appropriately selected from a conventionally known charge eliminating device. A suitable example thereof is a charge eliminating lamp.

The cleaning process is a process of removing the toner remaining on the electrostatic latent image bearing member. This is suitably performed by the cleaning unit.

The cleaning unit is not particularly limited as long as it is capable of eliminating such remaining electrophotographic toner from the electrostatic latent image bearing member, and can be suitably selected from known cleaners. Preferable examples thereof include a magnetic brush cleaner, an electrostatic brush cleaner, a magnetic roller cleaner, a blade cleaner, a brush cleaner, and a wave cleaner.

The recycling process is a process of recycling the toner, which has been removed in the cleaning process, to the developing unit. The process may be preferably carried out by a recycling unit.

The recycling unit is not particularly limited and can be appropriately selected from conventionally known conveyance units and the like.

The controlling process is a process of controlling each foregoing process. This is suitably performed by the control unit.

The control unit is not particularly limited as long as the operation of each unit can be controlled, and can be appropriately selected depending on the purpose. Examples thereof include equipment such as sequencers and computers.

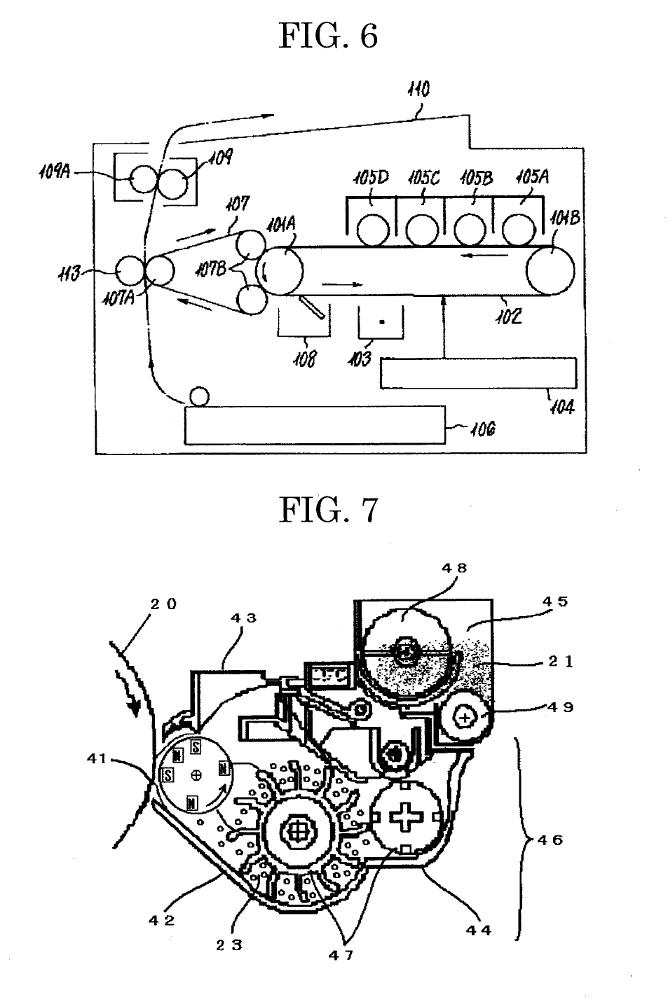

FIG. 6 shows one example of the image forming apparatus used in the image forming method of the present invention herein.

In FIG. 6, provided are a driving roller 101A, a driven roller 101B, a photoconductor belt 102, a charger 103, a laser writing unit 104, developing units 105A, 105B, 105C, and 105D containing respective toners of yellow, magenta, cyan, and black, a paper feed cassette 106, an intermediate transfer belt 107, a driving axial roller 107A to drive the intermediate transfer belt, a pair of driven axial rollers 107B to support the intermediate transfer belt, a cleaner 108, a fixing roller 109, a pressure roller 109A, a discharge tray 110, and a paper transfer roller 113.

This color image forming apparatus includes the intermediate transfer belt 107 that is flexible to the transfer drum. The intermediate transfer belt 107 as an intermediate transfer body is stretched between the driving axial roller 107A and the pair of driven axial rollers 107B and is circularly conveyed in a clockwise direction. A surface of the belt between the pair of driven axial rollers 107B is laterally in contact with the photoconductor belt 102 on the outer circumference of the driving roller 101A.

During normal color image output, toner images of each color to be formed on the photoconductor belt 102, are transferred onto the intermediate transfer belt 107 during every instance of image formation, and color toner images are composed thereon. The paper transfer roller 113 transfers all the toner images onto transfer paper fed from the paper feed cassette 106. The transfer paper after transferring is fed between the fixing roller 109 and the pressure roller 109A of the fixing device; and after fixing by the fixing roller 109 and the pressure roller 109A, the transfer paper is ejected onto the discharge tray 110.

When the developing units 105A to 105E develop the toner, the toner concentration of the developer stored in the developing unit decreases. A decrease in toner concentration of the developer is detected by a toner concentration detector (not shown). Upon detection of a decrease in toner concentration, a toner supplier (not shown) connected to each developing unit supplies toner to the connected developing unit so as to increase the toner concentration. When the developing units have a developer discharge mechanism, toner to be supplied may be a developer containing carrier and toner mixed for a so-called trickle developing system.

In FIG. 6, toner images are superimposed on the intermediate transfer belt to form an image. However, even in the system where images are directly transferred from a transfer drum onto a recording medium without an intermediate transfer belt, the electrophotographic image forming apparatus of the present invention can be provided in a similar way.

FIG. 7 shows one example of a developing apparatus used in the present invention. The following modifications are also within the range of the present invention.

In FIG. 7, a developing apparatus 40 disposed facing a photoconductor 20 as a latent image bearing member, is configured mainly of a developing sleeve 41 as a developer bearing member, a developer container 42, a doctor blade 43 serving as a regulation member, a support casing 44, etc.

The support casing 44 has an opening on a side of the photoconductor 20. A toner hopper 45 serving as a toner container for containing toner 21 is attached inside the support casing 44. A developer agitating mechanism 47 is arranged at a developer containing part 46 adjacent to the toner hopper 45 and contains a developer including the toner 21 and a carrier 23, so as to agitate the toner 21 and the carrier 23 to add friction/peel-off electric charge to the toner 21.

Inside the toner hopper 45, provided are a toner agitator 48 and a toner supplying mechanism 49 used as a toner supplying unit rotated by a driving unit not shown in the figures. The toner agitator 48 and the toner supplying mechanism 49 feed the toner 21 in the toner hopper 45 toward the developer containing part 46 while agitating the toner.

The developing sleeve 41 is arranged at a space between the photoconductor 20 and the toner hopper 45. The developing sleeve 41 that is rotated and driven in an arrow direction shown in FIG. 7 by a driving unit not shown in the figures, has a magnet (not shown) as magnetic field generating unit that is arranged therein at a constant relative position with respect to the developing apparatus 40, so as to form a magnetic brush by the carrier 23.

A doctor blade 43 is integrally provided to the developer container 42 on the opposite side of a support casing 44. The doctor blade 43 is arranged so as to provide a constant gap between the tip of the doctor blade 43 and the outer circumferential surface of the developing sleeve 41 in this example.

With unlimited use of such an apparatus, the image forming method of the present invention is carried out as follows. Specifically, in the configuration, the toner 21 that is fed from inside the toner hopper 45 by the toner agitator 48 and the toner supplying mechanism 49, is transported to the developer containing part 46, and then agitated by the developer agitating mechanism 47 to have a desirable frictional/peel-off charge. The toner is then carried on the developing sleeve 41, along with the carriers 23, as a developer, and is conveyed to a position facing the outer circumferential surface of the photoconductor 20. Only the toner 21 is then electrostatically bonded to an electrostatic latent image formed on the photoconductor 20, thus forming a toner image on the photoconductor 20.

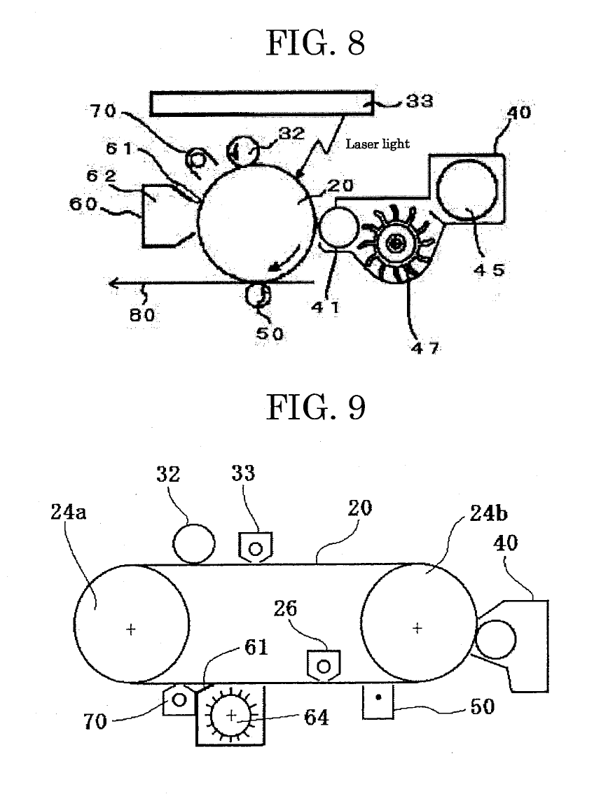

FIG. 8 shows one example of an image forming apparatus having the developing apparatus of FIG. 7. Around the drum-shape photoconductor 20, provided are a charging member 32, an image exposure system 33, the developing apparatus 40, a transfer apparatus 50, a cleaning device 60, and a neutralization lamp 70. With a gap of about 0.2 mm between the surface of the charging member 32 and the surface of the photoconductor 20, those surfaces are not in contact with each other. When the photoconductor 20 is charged by the charging member 32, the charging member 32 charges the photoconductor 20 with an electric field in which an alternating current component is overlapped with a direct current component by voltage supplying unit not shown in the figures, so that uneven charging can be reduced, which is effective. The image forming method including a developing method is carried out by the following processes.

A sequence of the image forming process can be explained with a negative-positive image forming process. The photoconductor 20, represented by a photoconductor (OPC) having an organic photoconductive layer, is neutralized by the neutralization lamp 70, and then evenly and negatively charged by the charging member 32, such as a charger and a charging roller. The charged photoconductor is then irradiated with laser light emitted from an image exposure system 33 such as a laser optical system, so that a latent image is formed thereon (In this embodiment, the absolute potential value of the exposed portion is lower than that of the non-exposed portion).

The laser light is emitted from a semiconductor laser. A polygonal columnar mirror rotating at high speed or the like, scans the surface of the photoconductor 20 with the laser light in the rotation axial direction of the photoconductor 20. The latent image formed thereby is then developed with a developer including a mixture of toner and a carrier supplied on the developing sleeve 41, as a developer bearing member, in the developing apparatus 40, thus forming a toner image. When developing a latent image, a voltage supplying mechanism (not shown) supplies a developing bias that is a direct current voltage of an appropriate level or in which an alternating current voltage is overlapped therewith, to the developing sleeve 41 and to a space between the exposed and non-exposed portions of the photoconductor 20.

On the other hand, a transfer medium 80 (e.g., paper) is fed from a paper feed mechanism (not shown). A pair of top and bottom registration rollers (not shown) feeds the transfer medium to a gap between the photoconductor 20 and the transfer apparatus 50 in synchronization with entry of the toner image, and then the toner image is transferred thereon. At that time, preferable is that a transfer bias that is an electric potential having polarity opposite to the polarity of the toner charge, is applied to the transfer apparatus 50. Thereafter, the transfer medium 80 is separated from the photoconductor 20, so that a transferred image is formed thereon.

The toner remaining on the photoconductor 20, is removed by a cleaning blade 61 as a cleaning member and is then recovered in a toner recovery chamber 62 inside the cleaning device 60.

The recovered toner may be conveyed to the developer containing part 46 and/or the toner hopper 45 by a toner recycling unit (not shown) for recycling.

The image forming apparatus may be an apparatus with a plurality of the above-described developing devices, where toner images are sequentially transferred onto a transfer medium and are then sent to a fixing mechanism to fix the toner with heat or the like. The image forming apparatus may also be an apparatus that transfers multiple toner images onto the intermediate transfer medium once and then fixes all the images on a transfer medium in the same manner as directed after the transfer.

FIG. 9 shows another example of an image forming apparatus used in the present invention. The photoconductor 20 has at least a photosensitive layer on a conductive substrate, and is driven by driving rollers 24a and 24b. The photoconductor 20 is subjected to the repeated process of charging by the charging member 32, image-exposure by the image exposure system 33, development by the developing apparatus 40, transfer by the transfer apparatus 50, pre-cleaning exposure by a pre-cleaning exposure light source 26, cleaning by a brush-type cleaning unit 64 and a cleaning blade 61, and neutralization by the neutralization lamp 70. In FIG. 9, pre-cleaning exposure is carried out on the photoconductor 20 from the side of the conductive substrate (in this embodiment, the conductive substrate is, of course, translucent).

### <Process Cartridge>

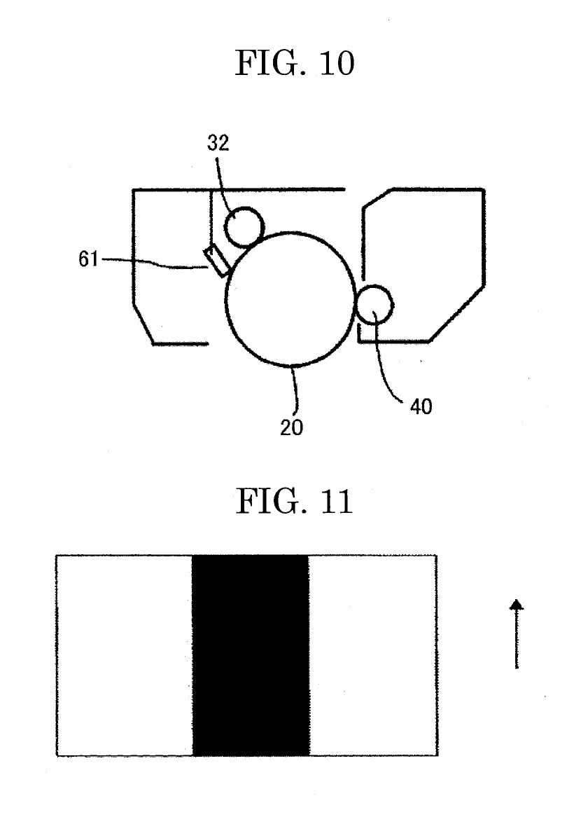

FIG. 10 is a schematic view, showing one example of a process cartridge used in the present invention. This process cartridge uses the developer of the present invention, and integrally supports the photoconductor 20, a proximity brush type contact charging unit 32, the developing unit 40 storing the developer used in the present invention, and cleaning unit having at least a cleaning blade 61 as cleaning unit. The process cartridge is detachably mountable to the body of an image forming apparatus.

In the present invention, the process cartridge may be configured by combining each of the above-described components in one body, so that the cartridge may be configured in a detachable manner to the body of an image forming apparatus such as a copier and a printer.

### EXAMPLES

The present invention will be explained by referring to examples and comparative examples. However, the present invention is not limited to the examples illustrated herein.

### <Crystalline Polyester Resin>

—Crystalline Polyesters a1 to a6—

TABLE 1

| | Glass transition | Softening | With or without | | |
|---|---|---|---|---|---|
| Crystalline | temperature Tg | temperature T½ | ester bond in | | Carboxylic acid |
| polyester (A) | [° C.] | [° C.] | formula (1) | Alcohol component | component |
| a1 | 98 | 104 | without | 1,5-Pentanediol | Fumaric acid |
| a2 | 81 | 86 | without | 1,4-Butanediol | Terephthalic acid |
| a3 | 84 | 89 | without | 1,5-Pentanediol | Maleic acid |
| a4 | 116 | 122 | without | 1,6-Hexanediol | Terephthalic acid |
| a5 | 119 | 126 | without | 1,5-Pentanediol | Terephthalic acid |
| a6 | 100 | 106 | with | 1,6-Hexanediol | Fumaric acid |

Crystalline polyesters a1 to a6 presented in Table 1 were resins obtained by using a compound selected from the group consisting of 1,4-butanediol, 1,5-pentanediol and 1,6-hexanediol as an alcohol component, and a compound selected from the group consisting of fumaric acid, maleic acid and terephthalic acid as a carboxylic acid component.

Specifically, these crystalline resins were obtained first by reacting monomers of the alcohol component and the carboxylic acid component presented in Table 1 with each other by esterification reaction under a normal pressure at 170° C. to 260° C. in a catalyst-free condition, then by adding antimony trioxide to the reacting system at 400 ppm with respect to the entire carboxylic acid components, and then by removing glycol from the reacting system under the vacuum of 3 Torr so as to carry out polycondensation at 250° C. Note that, the cross-linking reaction was carried out until agitation torque had become 10 kg·cm (100 ppm), and the reaction was stopped by removing the depressurization condition of the reacting system.

The crystalline polyesters a1 to a6 had at least one diffraction peak at the location of 2θ=19° to 25° in X-ray diffraction patterns by a powder X-ray diffraction apparatus, and were confirmed as crystalline polyesters. The X-ray diffraction results of the crystalline polyester resin a6 are shown in FIG. 4.

The glass transition temperatures (Tg) and the softening temperatures (T½) of the crystalline polyesters a1 to a6 are shown in Table 1.

Additionally, “with or without an ester bond in formula (1)” in Table 1 indicates whether or not there is an ester bond expressed by the following general formula (1).

[—OCO—R—COO—(CH₂)ₙ—] General Formula (1)

wherein R represents a linear unsaturated aliphatic dicarboxylic acid residue having 2 to 20 carbon atoms; and n is an integer from 2 to 20.

### <Non-Crystalline Resin>

—Non-Crystalline Resins b1 to b10 and c1 to c3—

TABLE 2

| | | | Glass | Chloroform | | |
|---|---|---|---|---|---|---|
| Non- | | Softening | transition | insoluble | | |
| Crystalline | | Point | point | matter | | |
| resin (B) | Material | [° C.] | [° C.] | [% by mass] | Acid component | Alcohol component |
| b1 | Polyester | 140 | 60 | 21 | Fumaric acid | Bisphenol A (2,2)propylene oxide |
| | | | | | Trimellitic anhydride | Bisphenol A (2,2)ethylene oxide |
| b2 | Polyester | 145 | 61 | 4 | Isophthalic acid | Bisphenol A (2,2)propylene oxide |
| | | | | | Trimellitic anhydride | Bisphenol A (2,2)ethylene oxide |
| b3 | Polyester | 140 | 60 | 6 | Fumaric acid | Bisphenol A (2,2)propylene oxide |
| | | | | | Trimellitic anhydride | Bisphenol A (2,2)ethylene oxide |
| b4 | Polyester | 151 | 62 | 39 | Dodecenyl succinic | Bisphenol A (2,2)propylene oxide |
| | | | | | anhydride | Bisphenol A (2,2)ethylene oxide |
| | | | | | Trimellitic anhydride | |
| b5 | Polyester | 141 | 59 | 41 | Fumaric acid | Ethylene glycol |
| | | | | | Trimellitic anhydride | Bisphenol A (2,2)propylene oxide |
| | | | | | | Bisphenol A (2,2)ethylene oxide |
| b6 | Styrene acrylic | 165 | 60 | 13 | Styrene/methyl acrylate copolymer resin | |
| b7 | Polyester | 150 | 50 | 18 | Dodecenyl succinic | Ethylene glycol |
| | | | | | anhydride | Bisphenol A (2,2)propylene oxide |
| | | | | | Trimellitic anhydride | Bisphenol A (2,2)ethylene oxide |
| b8 | Polyester | 145 | 53 | 21 | Fumaric acid | Ethylene glycol |
| | | | | | Trimellitic anhydride | Bisphenol A (2,2)propylene oxide |
| | | | | | | Bisphenol A (2,2)ethylene oxide |
| b9 | Polyester | 141 | 73 | 19 | Isophthalic acid | Ethylene glycol |
| | | | | | Trimellitic anhydride | Bisphenol A (2,2)propylene oxide |
| | | | | | | Bisphenol A (2,2)ethylene oxide |
| b10 | Polyester | 135 | 75 | 22 | Fumaric acid | Ethylene glycol |
| | | | | | Trimellitic anhydride | Bisphenol A (2,2)propylene oxide |
| | | | | | | Bisphenol A (2,2)ethylene oxide |

TABLE 3

| | | Softening | Glass | Molecular weight | | | |
|---|---|---|---|---|---|---|---|
| Non- | | temperature | transition | distribution | | | |
| crystalline | | T½b | temperature | Main | Half | | |
| resin (C) | Material | [° C.] | Tgb [° C.] | peak | width | Acid component | Alcohol component |
| c1 | Polyester | 100 | 63 | 5,000 | 17,000 | Fumaric acid | Bisphenol A (2,2)propylene oxide |
| | | | | | | | Bisphenol A (2,2)ethylene oxide |
| c2 | Styrene | 135 | 60 | 14,000 | 31,000 | Styrene/methyl acrylate copolymer resin | |
| | acryl | | | | | | |
| c3 | Polyester | 89 | 62 | 4,000 | 13,000 | Terephthalic acid | Bisphenol A (2,2)propylene oxide |
| | | | | | | Dodecenyl succinic | Bisphenol A (2,2)ethylene oxide |
| | | | | | | anhydride | |
| | | | | | | Trimellitic anhydride | |

Non-crystalline resins b1 to b5, b7 to b10, c1 and c3 presented in Tables 2 and 3 were resins obtained in the following manner.

Specifically, they were obtained first by reacting an aromatic diol component with a monomer selected from the group consisting of ethylene glycol, glycerin, adipic acid, terephthalic acid, isophthalic acid, and itaconic acid by esterification reaction under a normal pressure at 170° C. to 260° C. in a catalyst-free condition, then by adding antimony trioxide to the reacting system at 400 ppm with respect to the entire carboxylic acid components, and then by removing glycol from the reacting system under the vacuum of 3 Torr so as to carry out polycondensation at 250° C. Note that, the cross-linking reaction was carried out until agitation torque had become 10 kg·cm (100 ppm), and the reaction was stopped by removing the depressurization condition of the reacting system.

Also, the styrene/methyl acrylate copolymer resin as non-crystalline resin b6 or c2 presented in Table 2 and 3 was synthesized in the following manner.

Specifically, di-t-butylperoxide was homogeneously dissolved in a solution containing styrene and n-butyl arylate dissolved in xylene as a solvent. The resultant xylene solution was continuously supplied at 750 mL/hour to a 5 L-reactor which was maintained at 190° C. in internal temperature and 6 kg/cm² in internal pressure, to thereby obtain a solution of a styrene-acryl resin. Next, the resultant solution was flushed into a vessel at 90° C. and 10 mmHg to evaporate off the solvent. Thereafter, the obtained product was coarsely pulverized using a coarse pulverizer to obtain a styrene-acryl resin b6 or c2 as a chip of 1 mm.

It was confirmed that the non-crystalline resins b1 to b10 and c1 to c3 had no diffraction peak in accordance with X-ray diffraction patterns and were non-crystalline.

Additionally, the physical properties of the non-crystalline resins b1 to b10 and c1 to c3 are shown in Table 2 and Table 3.

(Preparation of Composite Resin d1)

In a 5-L, four-necked flask equipped with a nitrogen inlet tube, a dehydration tube, a stirrer, a dropping funnel and a thermocouple, 0.8 mol of terephthalic acid, 0.6 mol of fumaric acid, 0.8 mol of trimellitic anhydride, 1.1 mol of bisphenol A (2,2)propylene oxide and 0.5 mol of bisphenol A (2,2)ethylene oxide as condensation polymerization monomers, and 0.5 mol of dibutyl tin oxide as an esterification catalyst were placed. It was heated to 135° C. in a nitrogen atmosphere.

Under stirring, 10.5 mol of styrene, 3 mol of acrylic acid and 1.5 mol of 2-ethyl hexylacrylate as addition polymerization monomers and 0.24 mol of t-butyl hydroperoxide as a polymerization initiator were placed in the dropping funnel. The resultant mixture was added dropwise to the four-necked flask for 5 hours, and the reaction was performed for 6 hours.

Then, the temperature was raised to 210° C. for 3 hours, and a reaction was performed at 210° C. and 10 kPa until a desired softening temperature, whereby composite resin d1 was synthesized.

The obtained composite resin d1 was found to have a softening temperature of 115° C., a glass transition temperature of 58° C., and an acid value of 25 mgKOH/g.

(Preparation of Composite Resin d2)

A composite resin d2 was obtained in the same manner as in the preparation of Composite Resin d1 except that it was obtained using hexamethylene diamine and ∈-caprolactam as a condensation polymerization monomer and styrene, acrylic acid, and 2-ethylhexylacrylate as an addition polymerization monomer.

The unit configuration of the composite resins d1 and d2 is shown in Table 4.

TABLE 4

| Composite | Condensation | Addition polymerization |
|---|---|---|
| resin (D) | polymerization unit | resin unit |
| d1 | Polyester based | Vinyl based |
| d2 | Polyamide based | Vinyl based |

### <Preparation of Masterbatch>

| | |
|---|---|
| The above-described non-crystalline Resin c3 | 100 parts by mass |
| Colorant p2 (phthalocyanine blue, C.I. Pigment | 50 parts by mass |
| Blue 15:3) | |
| Purified water | 50 parts by mass |

A masterbatch was prepared by preliminarily kneading the above-described materials.

### Example 1A

### Preparation of Toner 1

| | |
|---|---|
| Crystalline polyester resin a1 | 4 parts by mass |
| Non-crystalline resin b1 | 35 parts by mass |
| Non-crystalline resin c1 | 55 parts by mass |
| Composite resin d1 | 10 parts by mass |
| Colorant p1 (Carbon Black) | 14 parts by mass |
| Releasing agent: carnauba wax (melting point: 81° C.) | 6 parts by mass |
| Charge controlling agent: monoazo metal complex | 2 parts by mass |
| (chromium complex dyestuff, Bontron S-34 made by | |
| Orient Chemical Industries Co., Ltd.) | |

After the above-mentioned toner materials were preliminarily mixed by using a Henschel mixer (FM20B made by Mitsui Miike Chemical Engineering Machinery, Co., Ltd.), the materials were melted and kneaded by a biaxial kneader (PCM-30 made by Ikegai Corp.) at a temperature of 100° C. to 130° C.

The kneaded product prepared thereby was rolled through rollers at a thickness of 2.8 mm, was cooled down to a room temperature by a belt cooler and was then coarsely ground by a hammer mill at 200 μm to 300 μm.

Subsequently, the material was finely ground by Supersonic Jet Mill LABOJET (manufactured by Nippon Pneumatic Mfg. Co., Ltd.), and was then classified by an air classifier (MDS-I produced by Nippon Pneumatic Mfg. Co., Ltd.) by appropriately adjusting a louver opening to provide a volume average particle diameter of 5.6 μm±0.2 μm, thus providing toner base particles.

Then, in respect to 100 parts by mass of the toner base particles provided thereby, 1.0 part by mass of an additive (HDK-2000 produced by Clariant (Japan) K.K.) was stirred and mixed by a Henschel mixer, thus preparing a pulverized toner 1.

A pulverized toner developer 1 was then prepared by evenly mixing 5% by mass of the prepared pulverized toner 1 and 95% by mass of a coating ferrite carrier for five minutes at 48 rpm by using the TURBULA mixer (manufactured by Willy A. Bachofen (WAB) AG Maschinenfabrik).

### Examples 2A to 33A and Comparative Examples 1A to 10A

### Preparation of Toners 2 to 43

In Example 1A, toners 2 to 43 were prepared as in Example 1A, except that the materials described in the following Tables 5-1 to 5-8 instead were melted and kneaded to prepare the toners.

Also, with each of the toners obtained thereby, developers 2 to 43 were prepared as in Example 1A.

Additionally, for a metal salicylate compound as a charge controlling agent used for the toners 38 to 43, a metal complex (Bontron E-84 produced by Orient Chemical Industries Co., Ltd.) was used as a zinc salicylate compound.

Moreover, since a pigment is poorly dispersed in the resins of the toner 31, a toner was prepared by using a masterbatch. In preparing the toner, the amount of the non-crystalline resin c3 contained in the masterbatch was counted backward, so that the ratios of the materials that were finally blended, were adjusted to the quantities shown in Tables 5-1 to 5-8.

Tables 6-1 to 6-6 show the main peaks of molecular weights of the pulverized toner prepared thereby, the half widths of molecular weight distribution, DSC peak temperature/endothermic energy amounts in a range from 90° C. to 130° C. derived from the crystalline polyester resin (A), whether or not there are diffraction peaks in a range from 19° C. to 25° C. by X-ray diffraction measurement, and volume average particle diameters.

TABLE 5-1

| | | | | Non- | Non- | | | | Charge | | Kneaded |
|---|---|---|---|---|---|---|---|---|---|---|---|
| | | | Crystalline | crystalline | crystalline | | | Releasing | Controlling | | product |
| | | | polyester (A) | Resin (B) | Resin (C) | | | Agent | Agent | Fatty Acid | thickness |
| | | | Material/ | Material/ | Material/ | Composite | Color- | Material/ | Material/ | Amide | during |
| | | | [parts by | [parts by | [parts by | Resin (D) | ant | [parts by | [parts by | [Parts by | cooling |
| | | | mass] | mass] | mass] | Part | Part | mass] | mass] | mass] | [mm] |
| Prodn. | Ex. 1A | Toner 1 | a1/4 | b1/35 | c1/55 | d1/10 | p1/14 | Carnauba | Monoazo | No | 2.8 |
| Ex. 1 | | | parts | parts | parts | parts | parts | wax/ | metal | | |
| | | | | | | | | 6 parts | complex/ | | |
| | | | | | | | | | 2 parts | | |
| Prodn. | Comp. | Toner 2 | No | b1/35 | c1/55 | d1/10 | p1/14 | Carnauba | Monoazo | No | 2.8 |
| Ex. 2 | Ex 1A | | | parts | parts | parts | parts | wax/ | metal | | |
| | | | | | | | | 6 parts | complex/ | | |
| | | | | | | | | | 2 parts | | |
| Prodn. | Comp. | Toner 3 | a1/4 | No | c1/90 | d1/10 | p1/14 | Carnauba | Monoazo | No | 2.8 |
| Ex. 3 | Ex. 2A | | parts | | parts | parts | parts | wax/ | metal | | |
| | | | | | | | | 6 parts | complex/ | | |
| | | | | | | | | | 2 parts | | |
| Prodn. | Comp. | Toner 4 | a1/4 | b1/90 | No | d1/10 | p1/14 | Carnauba | Monoazo | No | 2.8 |
| Ex. 4 | Ex. 3A | | parts | parts | | parts | parts | wax/ | metal | | |
| | | | | | | | | 6 parts | complex/ | | |
| | | | | | | | | | 2 parts | | |
| Prodn. | Comp. | Toner 5 | a1/4 | b1/35 | c1/55 | No | p1/14 | Carnauba | Monoazo | No | 2.8 |
| Ex. 5 | Ex. 4A | | parts | parts | parts | | parts | wax/ | metal | | |
| | | | | | | | | 6 parts | complex/ | | |
| | | | | | | | | | 2 parts | | |

TABLE 5-2

| | | | | Non- | Non- | | | | Charge | | Kneaded |
|---|---|---|---|---|---|---|---|---|---|---|---|
| | | | Crystalline | crystalline | crystalline | | | Releasing | Controlling | | product |
| | | | polyester (A) | Resin (B) | Resin (C) | | | Agent | Agent | Fatty Acid | thickness |
| | | | Material/ | Material/ | Material/ | Composite | Color- | Material/ | Material/ | Amide | during |
| | | | [parts by | [parts by | [parts by | Resin (D) | ant | [parts by | [parts by | [Parts by | cooling |
| | | | mass] | mass] | mass] | Part | Part | mass] | mass] | mass] | [mm] |
| Prodn. | Comp. | Toner 6 | a1/4 | b1/35 | c2/55 | d1/10 | p1/14 | Carnauba | Monoazo | No | 2.8 |
| Ex. 6 | Ex. 5A | | parts | parts | parts | parts | parts | wax/ | metal | | |
| | | | | | | | | 6 parts | complex/ | | |
| | | | | | | | | | 2 parts | | |
| Prodn. | Comp. | Toner 7 | a1/4 | b1/45 | c1/45 | d1/10 | p1/14 | Carnauba | Monoazo | No | 2.8 |
| Ex. 7 | Ex. 6A | | parts | parts | parts | parts | parts | wax/ | metal | | |
| | | | | | | | | 6 parts | complex/ | | |
| | | | | | | | | | 2 parts | | |
| Prodn. | Ex. 2A | Toner 8 | a1/4 | b1/40 | c1/50 | d1/10 | p1/14 | Carnauba | Monoazo | No | 2.8 |
| Ex. 8 | | | parts | parts | parts | parts | parts | wax/ | metal | | |
| | | | | | | | | 6 parts | complex/ | | |
| | | | | | | | | | 2 parts | | |
| Prodn. | Ex. 3A | Toner 9 | a1/4 | b1/25 | c1/65 | d1/10 | p1/14 | Carnauba | Monoazo | No | 2.8 |
| Ex. 9 | | | parts | parts | parts | parts | parts | wax/ | metal | | |
| | | | | | | | | 6 parts | complex/ | | |
| | | | | | | | | | 2 parts | | |
| Prodn. | Comp. | Toner 10 | a1/4 | b1/20 | c1/70 | d1/10 | p1/14 | Carnauba | Monoazo | No | 2.8 |
| Ex 10 | Ex. 7A | | parts | parts | parts | parts | parts | wax/ | metal | | |
| | | | | | | | | 6 parts | complex/ | | |
| | | | | | | | | | 2 parts | | |
| Prodn. | Ex. 4A | Toner 11 | a1/4 | b1/28 | c1/62 | d1/5 | p1/14 | Carnauba | Monoazo | No | 2.8 |
| Ex. 11 | | | parts | parts | parts | parts | parts | wax/ | metal | | |
| | | | | | | | | 6 parts | complex/ | | |
| | | | | | | | | | 2 parts | | |

TABLE 5-3

| | | | | Non- | Non- | | | | Charge | | Kneaded |
|---|---|---|---|---|---|---|---|---|---|---|---|
| | | | Crystalline | crystalline | crystalline | | | Releasing | Controlling | | product |
| | | | polyester (A) | Resin (B) | Resin (C) | | | Agent | Agent | Fatty Acid | thickness |
| | | | Material/ | Material | Material/ | Composite | Color- | Material/ | Material/ | Amide | during |
| | | | [parts by | [parts by | [parts by | Resin (D) | ant | [parts by | [parts by | [Parts by | cooling |
| | | | mass] | mass] | mass] | Part | Part | mass] | mass] | mass] | [mm] |
| Prodn. | Comp. | Toner 12 | a1/4 | b1/30 | c1/60 | d1/5 | p1/14 | Carnauba | Monoazo | No | 2.8 |
| Ex. 12 | Ex. 8A | | parts | parts | parts | parts | parts | wax/ | metal | | |
| | | | | | | | | 6 parts | complex/ | | |
| | | | | | | | | | 2 parts | | |
| Prodn. | Ex. 5A | Toner 13 | a2/4 | b1/35 | c1/55 | d1/10 | p1/14 | Carnauba | Monoazo | No | 2.8 |
| Ex. 13 | | | parts | parts | parts | parts | parts | wax/ | metal | | |
| | | | | | | | | 6 parts | complex/ | | |
| | | | | | | | | | 2 parts | | |
| Prodn. | Ex. 6A | Toner 14 | a3/4 | b1/35 | c1/55 | d1/10 | p1/14 | Carnauba | Monoazo | No | 2.8 |
| Ex. 14 | | | parts | parts | parts | parts | parts | wax/ | metal | | |
| | | | | | | | | 6 parts | complex/ | | |
| | | | | | | | | | 2 parts | | |
| Prodn. | Ex. 7A | Toner 15 | a4/4 | b1/35 | c1/55 | d1/10 | p1/14 | Carnauba | Monoazo | No | 2.8 |
| Ex. 15 | | | parts | parts | parts | parts | parts | wax/ | metal | | |
| | | | | | | | | 6 parts | complex/ | | |
| | | | | | | | | | 2 parts | | |
| Prodn. | Ex. 8A | Toner 16 | a5/4 | b1/35 | c1/55 | d1/10 | p1/14 | Carnauba | Monoazo | No | 2.8 |
| Ex. 16 | | | parts | parts | parts | parts | parts | wax/ | metal | | |
| | | | | | | | | 6 parts | complex/ | | |
| | | | | | | | | | 2 parts | | |
| Prodn. | Ex. 9A | Toner 17 | a1/1 | b1/35 | c1/55 | d1/10 | p1/14 | Carnauba | Monoazo | No | 2.8 |
| Ex. 17 | | | part | parts | parts | parts | parts | wax/ | metal | | |
| | | | | | | | | 6 parts | complex/ | | |
| | | | | | | | | | 2 parts | | |

TABLE 5-4

| | | | | Non- | Non- | | | | Charge | | Kneaded |
|---|---|---|---|---|---|---|---|---|---|---|---|
| | | | Crystalline | crystalline | crystalline | | | Releasing | Controlling | | product |
| | | | polyester (A) | Resin (B) | Resin (C) | | | Agent | Agent | Fatty Acid | thickness |
| | | | Material/ | Material/ | Material/ | Composite | Color- | Material/ | Material/ | Amide | during |
| | | | [parts by | [parts by | [parts by | Resin (D) | ant | [parts by | [parts by | [Parts by | cooling |
| | | | mass] | mass] | mass] | Part | Part | mass] | mass] | mass] | [mm] |
| Prodn. | Ex. 10A | Toner 18 | a1/2 | b1/35 | c1/55 | d1/10 | p1/14 | Carnauba | Monoazo | No | 2.8 |
| Ex. 18 | | | parts | parts | parts | parts | parts | wax/ | metal | | |
| | | | | | | | | 6 parts | complex/ | | |
| | | | | | | | | | 2 parts | | |
| Prodn. | Ex. 11A | Toner 19 | a1/16 | b1/35 | c1/55 | d1/10 | p1/14 | Carnauba | Monoazo | No | 2.8 |
| Ex. 19 | | | parts | parts | parts | parts | parts | wax/ | metal | | |
| | | | | | | | | 6 parts | complex/ | | |
| | | | | | | | | | 2 parts | | |
| Prodn. | Ex. 12A | Toner 20 | a1/19 | b1/35 | c1/55 | d1/10 | p1/14 | Carnauba | Monoazo | No | 2.8 |
| Ex. 20 | | | parts | parts | parts | parts | parts | wax/ | metal | | |
| | | | | | | | | 6 parts | complex/ | | |
| | | | | | | | | | 2 parts | | |
| Prodn. | Ex. 13A | Toner 21 | a1/4 | b1/35 | c3/55 | d1/10 | p1/14 | Carnauba | Monoazo | No | 2.8 |
| Ex. 21 | | | parts | parts | parts | parts | parts | wax/ | metal | | |
| | | | | | | | | 6 parts | complex/ | | |
| | | | | | | | | | 2 parts | | |
| Prodn. | Ex. 14A | Toner 22 | a1/4 | b1/35 | c3/55 | d1/10 | p1/14 | Carnauba | Monoazo | N,N-Ethyl- | 2.8 |
| Ex. 22 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 15A | Toner 23 | a1/4 | b2/35 | c3/55 | d1/10 | p1/14 | Carnauba | Monoazo | N,N-Ethyl- | 2.8 |
| Ex. 23 | | | parts | parts | parts | parts | parts | wax/ | metal | enebis- | |
| | | | | | | | | 6 parts | complex/ | (Stearamide)/ | |
| | | | | | | | | | 2 parts | 2 parts | |

TABLE 5-5

| | | | | Non- | Non- | | | | Charge | | Kneaded |
|---|---|---|---|---|---|---|---|---|---|---|---|
| | | | Crystalline | crystalline | crystalline | | | Releasing | Controlling | | product |
| | | | polyester (A) | Resin (B) | Resin (C) | | | Agent | Agent | Fatty Acid | thickness |
| | | | Material/ | Material/ | Material/ | Composite | Color- | Material/ | Material/ | Amide | during |
| | | | [parts by | [parts by | [parts by | Resin (D) | ant | [parts by | [parts by | [Parts by | cooling |
| | | | mass] | mass] | mass] | Part | Part | mass] | mass] | mass] | [mm] |
| Prodn. | Ex. 16A | Toner 24 | a1/4 | b3/35 | c3/55 | d1/10 | p1/14 | Carnauba | Monoazo | N,N-Ethyl- | 2.8 |
| Ex. 24 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 17A | Toner 25 | a1/4 | b4/35 | c3/55 | d1/10 | p1/14 | Carnauba | Monoazo | N,N-Ethyl- | 2.8 |
| Ex. 25 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 18A | Toner 26 | a1/4 | b5/35 | c3/55 | d1/10 | p1/14 | Carnauba | Monoazo | N,N-Ethyl- | 2.8 |
| Ex. 26 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 19A | Toner 27 | a1/4 | b3/10 | c3/80 | d1/10 | p1/14 | Carnauba | Monoazo | N,N-Ethyl- | 2.8 |
| Ex. 27 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 20A | Toner 28 | a1/4 | b3/15 | c3/75 | d1/10 | p1/14 | Carnauba | Monoazo | N,N-Ethyl- | 2.8 |
| Ex. 28 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 21A | Toner 29 | a1/4 | b4/15 | c3/75 | d1/10 | p1/14 | Carnauba | Monoazo | N,N-Ethyl- | 2.8 |
| Ex. 29 | | | parts | parts | parts | parts | parts | wax/ | metal | enebis- | |
| | | | | | | | | 6 parts | complex/ | (Stearamide)/ | |
| | | | | | | | | | 2 parts | 2 parts | |

TABLE 5-6

| | | | | Non- | Non- | | | | Charge | | Kneaded |
|---|---|---|---|---|---|---|---|---|---|---|---|
| | | | Crystalline | crystalline | crystalline | | | Releasing | Controlling | | product |
| | | | polyester (A) | Resin (B) | Resin (C) | | | Agent | Agent | Fatty Acid | thickness |
| | | | Material/ | Material/ | Material/ | Composite | Color- | Material/ | Material/ | Amide | during |
| | | | [parts by | [parts by | [parts by | Resin (D) | ant | [parts by | [parts by | [Parts by | cooling |
| | | | mass] | mass] | mass] | Part | Part | mass] | mass] | mass] | [mm] |
| Prodn. | Ex. 22A | Toner 30 | a1/4 | b4/20 | c3/70 | d1/10 | p1/14 | Carnauba | Monoazo | N,N-Ethyl- | 2.8 |
| Ex. 30 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 23A | Toner 31 | a1/4 | b1/35 | c3/55 | d1/10 | p2/14 | Carnauba | Monoazo | N,N-Ethyl- | 2.8 |
| Ex. 31 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 24A | Toner 32 | a1/4 | b6/35 | c2/55 | d1/10 | p1/14 | Carnauba | Monoazo | N,N-Ethyl- | 2.8 |
| Ex. 32 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 25A | Toner 33 | a1/4 | b6/35 | c3/55 | d1/10 | p1/14 | Carnauba | Monoazo | N,N-Ethyl- | 2.8 |
| Ex. 33 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 26A | Toner 34 | a1/4 | b1/35 | c3/55 | d1/10 | p1/14 | Polyethyl- | Monoazo | N,N-Ethyl- | 2.8 |
| Ex. 34 | | | parts | parts | parts | parts | parts | ene wax/ | metal | enebis- | |
| | | | | | | | | 6 parts | complex/ | (Stearamide)/ | |
| | | | | | | | | | 2 parts | 2 parts | |
| Prodn. | Ex. 27A | Toner 35 | a6/1 | b1/35 | c3/55 | d1/10 | p1/14 | Carnauba | Monoazo | N,N-Ethyl- | 2.8 |
| Ex. 35 | | | parts | parts | parts | parts | parts | wax/ | metal | enebis- | |
| | | | | | | | | 6 parts | complex/ | (Stearamide)/ | |
| | | | | | | | | | 2 parts | 2 parts | |

TABLE 5-7

| | | | | Non- | Non- | | | | Charge | | Kneaded |
|---|---|---|---|---|---|---|---|---|---|---|---|
| | | | Crystalline | crystalline | crystalline | | | Releasing | Controlling | | product |
| | | | polyester (A) | Resin (B) | Resin (C) | | | Agent | Agent | Fatty Acid | thickness |
| | | | Material/ | Material/ | Material/ | Composite | Color- | Material/ | Material/ | Amide | during |
| | | | [parts by | [parts by | [parts by | Resin (D) | ant | [parts by | [parts by | [Parts by | cooling |
| | | | mass] | mass] | mass] | Part | Part | mass] | mass] | mass] | [mm] |
| Prodn. | Ex. 28A | Toner 36 | a6/4 | b1/35 | c3/55 | d2/10 | p1/14 | Carnauba | Monoazo | N,N-Ethyl- | 2.8 |
| Ex. 36 | | | parts | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Ex. 29A | Toner 37 | a1/1 | b1/35 | c3/55 | d1/10 | p1/14 | Carnauba | Monoazo | N,N-Ethyl- | 2.6 |
| Ex. 37 | | | part | parts | parts | parts | parts | wax/ | metal | enebis- | |
| | | | | | | | | 6 parts | complex/ | (Stearamide)/ | |
| | | | | | | | | | 2 parts | 2 parts | |
| Prodn. | Comp. | Toner 38 | a6/4 | b7/35 | c3/55 | d1/10 | p1/14 | Carnauba | Metal | N,N-Ethyl- | 2.8 |
| Ex. 38 | Ex. 9A | | parts | parts | parts | parts | parts | wax/ | salicylate | enebis- | |
| | | | | | | | | 6 parts | compound/ | (Stearamide)/ | |
| | | | | | | | | | 2 parts | 2 parts | |
| Prodn. | Ex. 30A | Toner 39 | a6/4 | b8/35 | c3/55 | d1/10 | p1/14 | Carnauba | Metal | N,N-Ethyl- | 2.8 |
| Ex. 39 | | | parts | parts | parts | parts | parts | wax/ | salicylate | enebis- | |
| | | | | | | | | 6 parts | compound/ | (Stearamide)/ | |
| | | | | | | | | | 2 parts | 2 parts | |
| Prodn. | Ex. 31A | Toner 40 | a6/4 | b9/35 | c1/55 | d1/10 | p1/14 | Carnauba | Metal | N,N-Ethyl- | 2.8 |
| Ex. 40 | | | parts | parts | parts | parts | parts | wax/ | salicylate | enebis- | |
| | | | | | | | | 6 parts | compound/ | (Stearamide)/ | |
| | | | | | | | | | 2 parts | 2 parts | |
| Prodn. | Comp. | Toner 41 | a6/4 | b10/35 | c3/55 | d1/10 | p1/14 | Carnauba | Metal | N,N-Ethyl- | 2.8 |
| Ex. 41 | Ex. 10A | | parts | parts | parts | parts | parts | wax/ | salicylate | enebis- | |
| | | | | | | | | 6 parts | compound/ | (Stearamide)/ | |
| | | | | | | | | | 2 parts | 2 parts | |

TABLE 5-8

| | | | | Non- | Non- | | | | Charge | | Kneaded |
|---|---|---|---|---|---|---|---|---|---|---|---|
| | | | Crystalline | crystalline | crystalline | | | Releasing | Controlling | | product |
| | | | polyester (A) | Resin (B) | Resin (C) | | | Agent | Agent | Fatty Acid | thickness |
| | | | Material/ | Material/ | Material/ | Composite | Color- | Material/ | Material/ | Amide | during |
| | | | [parts by | [parts by | [parts by | Resin (D) | ant | [parts by | [parts by | [Parts by | cooling |
| | | | mass] | mass] | mass] | Part | Part | mass] | mass] | mass] | [mm] |
| Prodn. | Ex. 32A | Toner 42 | a6/4 | b1/35 | c3/55 | d1/10 | p1/14 | Carnauba | Metal | N,N-Ethyl- | 2.2 |
| Ex. 42 | | | parts | parts | parts | parts | parts | wax/ | salicylate | enebis- | |
| | | | | | | | | 6 parts | compound/ | (Stearamide)/ | |
| | | | | | | | | | 2 parts | 2 parts | |
| Prodn. | Ex. 33A | Toner 43 | a6/4 | b1/35 | c3/55 | d1/10 | p1/14 | Carnauba | Metal | N,N-Ethyl- | 2.8 |
| Ex. 43 | | | parts | parts | parts | parts | parts | wax/ | salicylate | enebis- | |
| | | | | | | | | 6 parts | compound/ | (Stearamide)/ | |
| | | | | | | | | | 2 parts | 2 parts | |

TABLE 6-1

| | | | Non- | Non- | | | | Half width of |
|---|---|---|---|---|---|---|---|---|
| | | Crystalline | crystalline | Crystalline | Composite | | Main peak of | toner molecular |
| | | polyester (A) | resin (B) | resin (C) | resin (D) | Colorant | toner M.W. | weight |
| Ex. 1A | Toner 1 | a1 | b1 | c1 | d1 | p1 | 7400 | 13000 |
| Comp. | Toner 2 | — | b1 | c1 | d1 | p1 | 7400 | 13000 |
| Ex. 1A | | | | | | | | |
| Comp. | Toner 3 | a1 | — | c1 | d1 | p1 | 7400 | 13000 |
| Ex. 2A | | | | | | | | |
| Comp. | Toner 4 | a1 | b1 | — | d1 | p1 | 7600 | 105000 |
| Ex. 3A | | | | | | | | |
| Comp. | Toner 5 | a1 | b1 | c1 | — | p1 | 7400 | 13000 |
| Ex. 4A | | | | | | | | |
| Comp. | Toner 6 | a1 | b1 | c2 | d1 | p1 | 9500 | 14000 |
| Ex. 5A | | | | | | | | |
| Comp. | Toner 7 | a1 | b1 | cl | d1 | p1 | 900 | 9000 |
| Ex. 6A | | | | | | | | |

| | | Endothermic | | | | |
|---|---|---|---|---|---|---|
| | DSC peak | energy amount | | | | X-ray |
| | Temp. in | of DSC peak in | | | | diffraction |
| | range from | range from | | Charge | | peak in |
| | 90 to 130° C. | 90 to 130° C. | Releasing | Controlling | Fatty acid | range from |
| | [° C.] | [J/g] | Agent | Agent | amide compound | 19° to 25° |
| Ex. 1A | 108 | 5 | Carnauba | Monoazo | No | Yes |
| | | | wax | metal | | |
| | | | | complex | | |
| Comp. | — | — | Carnauba | Monoazo | No | No |
| Ex. 1A | | | wax | metal | | |
| | | | | complex | | |
| Comp. | 108 | 5 | Carnauba | Monoazo | No | Yes |
| Ex. 2A | | | wax | metal | | |
| | | | | complex | | |
| Comp. | 108 | 5 | Carnauba | Monoazo | No | Yes |
| Ex. 3A | | | wax | metal | | |
| | | | | complex | | |
| Comp. | 108 | 5 | Carnauba | Monoazo | No | Yes |
| Ex. 4A | | | wax | metal | | |
| | | | | complex | | |
| Comp. | 108 | 5 | Carnauba | Monoazo | No | Yes |
| Ex. 5A | | | wax | metal | | |
| | | | | complex | | |
| Comp. | 108 | 5 | Carnauba | Monoazo | No | Yes |
| Ex. 6A | | | wax | metal | | |
| | | | | complex | | |

TABLE 6-2

| | | | Non- | Non- | | | | Half width of |
|---|---|---|---|---|---|---|---|---|
| | | Crystalline | crystalline | Crystalline | Composite | | Main peak of | toner molecular |
| | | polyester (A) | resin (B) | resin (C) | resin (D) | Colorant | toner M.W. | weight |
| Ex. 2A | Toner 8 | a1 | b1 | c1 | d1 | p1 | 1100 | 10000 |
| Ex. 3A | Toner 9 | a1 | b1 | c1 | d1 | p1 | 9800 | 13800 |
| Comp. | Toner 10 | a1 | b1 | c1 | d1 | p1 | 11000 | 14100 |
| Ex. 7A | | | | | | | | |
| Ex. 4A | Toner 11 | a1 | b1 | c1 | d1 | p1 | 8800 | 14500 |
| Cop. | Toner 12 | a1 | b1 | c1 | d1 | p1 | 9000 | 16000 |
| Ex. 8A | | | | | | | | |
| Ex. 5A | Toner 13 | a2 | b1 | c1 | d1 | p1 | 7400 | 13000 |
| Ex. 6A | Toner 14 | a3 | b1 | c1 | d1 | p1 | 7400 | 13000 |

| | | Endothermic | | | | |
|---|---|---|---|---|---|---|
| | DSC peak | energy amount | | | | X-ray |
| | Temp. in | of DSC peak in | | | | diffraction |
| | range from | range from | | Charge | | peak in |
| | 90 to 130° C. | 90 to 130° C. | Releasing | Controlling | Fatty acid | range from |
| | [° C.] | [J/g] | Agent | Agent | amide compound | 19° to 25° |
| Ex. 2A | 108 | 5 | Carnauba | Monoazo | No | Yes |
| | | | wax | metal | | |
| | | | | complex | | |
| Ex. 3A | 108 | 5 | Carnauba | Monoazo | No | No |
| | | | wax | metal | | |
| | | | | complex | | |
| Comp. | 108 | 5 | Carnauba | Monoazo | No | Yes |
| Ex. 7A | | | wax | metal | | |
| | | | | complex | | |
| Ex. 4A | 108 | 5 | Carnauba | Monoazo | No | Yes |
| | | | wax | metal | | |
| | | | | complex | | |
| Cop. | 108 | 5 | Carnauba | Monoazo | No | Yes |
| Ex. 8A | | | wax | metal | | |
| | | | | complex | | |
| Ex. 5A | 88 | 5 | Carnauba | Monoazo | No | Yes |
| | | | wax | metal | | |
| | | | | complex | | |
| Ex. 6A | 92 | 5 | Carnauba | Monoazo | No | Yes |
| | | | wax | metal | | |
| | | | | complex | | |

TABLE 6-3

| | | | Non- | Non- | | | | Half width of |
|---|---|---|---|---|---|---|---|---|
| | | Crystalline | crystalline | Crystalline | Composite | | Main peak of | toner molecular |
| | | polyester (A) | resin (B) | resin (C) | resin (D) | Colorant | toner M.W. | weight |
| Ex. 7A | Toner 15 | a4 | b1 | c1 | d1 | p1 | 7400 | 13000 |
| Ex. 8A | Toner 16 | a5 | b1 | c1 | d1 | p1 | 7400 | 13000 |
| Ex. 9A | Toner 17 | a1 | b1 | c1 | d1 | p1 | 7400 | 13000 |
| Ex. 10A | Toner 18 | a1 | b1 | c1 | d1 | p1 | 7400 | 13000 |
| Ex. 11A | Toner 19 | a1 | b1 | c1 | d1 | p1 | 7400 | 13000 |
| Ex. 12A | Toner 20 | a1 | b1 | c1 | d1 | p1 | 7400 | 13000 |
| Ex. 13A | Toner 21 | a1 | b1 | c3 | d1 | p1 | 7000 | 13000 |

| | | Endothermic | | | | |
|---|---|---|---|---|---|---|
| | DSC peak | energy amount | | | | X-ray |
| | Temp. in | of DSC peak in | | | | diffraction |
| | range from | range from | | Charge | | peak in |
| | 90 to 130° C. | 90 to 130° C. | Releasing | Controlling | Fatty acid | range from |
| | [° C.] | [J/g] | Agent | Agent | amide compound | 19° to 25° |
| Ex. 7A | 127 | 5 | Carnauba | Monoazo | No | Yes |
| | | | wax | metal | | |
| | | | | complex | | |
| Ex. 8A | 131 | 5 | Carnauba | Monoazo | No | Yes |
| | | | wax | metal | | |
| | | | | complex | | |
| Ex. 9A | 108 | 0.5 | Carnauba | Monoazo | No | Yes |
| | | | wax | metal | | |
| | | | | complex | | |
| Ex. 10A | 108 | 2 | Carnauba | Monoazo | No | Yes |
| | | | wax | metal | | |
| | | | | complex | | |
| Ex. 11A | 108 | 14 | Carnauba | Monoazo | No | Yes |
| | | | wax | metal | | |
| | | | | complex | | |
| Ex. 12A | 108 | 16 | Carnauba | Monoazo | No | Yes |
| | | | wax | metal | | |
| | | | | complex | | |
| Ex. 13A | 108 | 5 | Carnauba | Monoazo | No | Yes |
| | | | wax | metal | | |
| | | | | complex | | |

TABLE 6-4

| | | Crystalline | Non- | Non- | | | | Half width of |
|---|---|---|---|---|---|---|---|---|
| | | polyester | crystalline | Crystalline | Composite | | Main peak of | toner molecular |
| | | (A) | resin (B) | resin (C) | resin (D) | Colorant | toner M.W. | weight |
| Ex. 14A | Toner 22 | a1 | b1 | c3 | d1 | p1 | 6500 | 13000 |
| Ex. 15A | Toner 23 | a1 | b2 | c3 | d1 | p1 | 3400 | 8900 |
| Ex. 16A | Toner 24 | a1 | b3 | c3 | d1 | p1 | 3800 | 9500 |
| Ex. 17A | Toner 25 | a1 | b4 | c3 | d1 | p1 | 7500 | 13100 |
| Ex. 18A | Toner 26 | a1 | b5 | c3 | d1 | p1 | 8000 | 13400 |
| Ex. 19A | Toner 27 | a1 | b3 | c3 | d1 | p1 | 3500 | 8500 |
| Ex. 20A | Toner 28 | a1 | b3 | c3 | d1 | p1 | 4000 | 9000 |

| | | Endothermic | | | | |
|---|---|---|---|---|---|---|
| | DSC peak | energy amount | | | | X-ray |
| | Temp. in | of DSC peak in | | | | diffraction |
| | range from | range from | | Charge | | peak in |
| | 90 to 130° C. | 90 to 130° C. | Releasing | Controlling | Fatty acid | range from |
| | [° C.] | [J/g] | Agent | Agent | amide compound | 19° to 25° |
| Ex. 14A | 108 | 5 | Carnauba | Monoazo | Yes | Yes |
| | | | wax | metal | | |
| | | | | complex | | |
| Ex. 15A | 108 | 5 | Carnauba | Monoazo | Yes | Yes |
| | | | wax | metal | | |
| | | | | complex | | |
| Ex. 16A | 108 | 5 | Carnauba | Monoazo | Yes | Yes |
| | | | wax | metal | | |
| | | | | complex | | |
| Ex. 17A | 108 | 5 | Carnauba | Monoazo | Yes | Yes |
| | | | wax | metal | | |
| | | | | complex | | |
| Ex. 18A | 108 | 5 | Carnauba | Monoazo | Yes | Yes |
| | | | wax | metal | | |
| | | | | complex | | |
| Ex. 19A | 108 | 5 | Carnauba | Monoazo | Yes | Yes |
| | | | wax | metal | | |
| | | | | complex | | |
| Ex. 20A | 108 | 5 | Carnauba | Monoazo | Yes | Yes |
| | | | wax | metal | | |
| | | | | complex | | |

TABLE 6-5

| | | | Non- | Non- | | | | Half width, of |
|---|---|---|---|---|---|---|---|---|
| | | Crystalline | crystalline | Crystalline | Composite | | Main peak of | toner molecular |
| | | polyester (A) | resin (B) | resin (C) | resin (D) | Colorant | toner M.W. | weight |
| Ex. 21A | Toner 29 | a1 | b4 | c3 | d1 | p1 | 9300 | 12800 |
| Ex. 22A | Toner 30 | a1 | b4 | c3 | d1 | p1 | 9500 | 13000 |
| Ex. 23A | Toner 31 | a1 | b1 | c3 | d1 | p2 | 7000 | 12500 |
| Ex. 24A | Toner 32 | a1 | b6 | c2 | d1 | p1 | 9000 | 13500 |
| Ex. 25A | Toner 33 | a1 | b6 | c3 | d1 | p1 | 7700 | 13000 |
| Ex. 26A | Toner 34 | a1 | b1 | c3 | d1 | p1 | 6900 | 12500 |
| Ex. 27A | Toner 35 | a6 | b1 | c3 | d1 | p1 | 7200 | 12500 |

| | | Endothermic | | | | |
|---|---|---|---|---|---|---|
| | DSC peak | energy amount | | | | X-ray |
| | Temp. in | of DSC peak in | | | | diffraction |
| | range from | range from | | Charge | | peak in |
| | 90 to 130° C. | 90 to 130° C. | Releasing | Controlling | Fatty acid | range from |
| | [° C.] | [J/g] | Agent | Agent | amide compound | 19° to 25° |
| Ex. 21A | 108 | 5 | Carnauba | Monoazo | Yes | Yes |
| | | | wax | metal | | |
| | | | | complex | | |
| Ex. 22A | 108 | 5 | Carnauba | Monoazo | Yes | Yes |
| | | | wax | metal | | |
| | | | | complex | | |
| Ex. 23A | 108 | 5 | Carnauba | Monoazo | Yes | Yes |
| | | | wax | metal | | |
| | | | | complex | | |
| Ex. 24A | 108 | 5 | Carnauba | Monoazo | Yes | Yes |
| | | | wax | metal | | |
| | | | | complex | | |
| Ex. 25A | 108 | 5 | Carnauba | Monoazo | Yes | Yes |
| | | | wax | metal | | |
| | | | | complex | | |
| Ex. 26A | 108 | 5 | Polyethylene | Monoazo | Yes | Yes |
| | | | wax | metal | | |
| | | | | complex | | |
| Ex. 27A | 110 | 5 | Carnauba | Monoazo | Yes | Yes |
| | | | wax | metal | | |
| | | | | complex | | |

TABLE 6-6

| | | | Non- | Non- | | | | Half width of |
|---|---|---|---|---|---|---|---|---|
| | | Crystalline | crystalline | Crystalline | Composite | | Main peak of | toner molecular |
| | | polyester (A) | resin (B) | resin (C) | resin (D) | Colorant | toner M.W. | weight |
| Ex. 28A | Toner 36 | a6 | b1 | c3 | d2 | p1 | 7000 | 12500 |
| Ex. 29A | Toner 37 | a1 | b1 | c3 | d1 | p1 | 6000 | 12500 |
| Comp. | Toner 38 | a6 | b7 | c3 | d1 | p1 | 6000 | 9000 |
| Ex. 9A | | | | | | | | |
| Ex. 30A | Toner 39 | a6 | b8 | c3 | d1 | p1 | 6000 | 9500 |
| Ex. 31A | Toner 40 | a6 | b9 | c1 | d1 | p1 | 8800 | 14000 |
| Comp. | Toner 41 | a6 | b10 | c3 | d1 | p1 | 9000 | 15000 |
| Ex. 10A | | | | | | | | |
| Ex. 32A | Toner 42 | a6 | b1 | c3 | d1 | p1 | 7000 | 12500 |
| Ex. 33A | Toner 43 | a6 | b1 | c3 | d1 | p1 | 7000 | 12500 |

| | | Endothermic | | | | |
|---|---|---|---|---|---|---|
| | DSC peak | energy amount | | | | X-ray |
| | Temp. in | of DSC peak in | | | | diffraction |
| | range from | range from | | Charge | | peak in |
| | 90 to 130° C. | 90 to 130° C. | Releasing | Controlling | Fatty acid | range from |
| | [° C.] | [J/g] | Agent | Agent | amide compound | 19° to 25° |
| Ex. 28A | 110 | 5 | Carnauba | Monoazo | Yes | Yes |
| | | | wax | metal | | |
| | | | | complex | | |
| Ex. 29A | 108 | 2 | Carnauba | Monoazo | Yes | No |
| | | | wax | metal | | |
| | | | | complex | | |
| Comp. | 110 | 5 | Carnauba | Metal | Yes | Yes |
| Ex. 9A | | | wax | salicylate | | |
| | | | | compound | | |
| Ex. 30A | 110 | 5 | Carnauba | Metal | Yes | Yes |
| | | | wax | salicylate | | |
| | | | | compound | | |
| Ex. 31A | 110 | 5 | Carnauba | Metal | Yes | Yes |
| | | | wax | salicylate | | |
| | | | | compound | | |
| Comp. | 110 | 5 | Carnauba | Metal | Yes | Yes |
| Ex. 10A | | | wax | salicylate | | |
| | | | | compound | | |
| Ex. 32A | 110 | 3 | Carnauba | Metal | Yes | Yes |
| | | | wax | salicylate | | |
| | | | | compound | | |
| Ex. 33A | 110 | 5 | Carnauba | Metal | Yes | Yes |
| | | | wax | salicylate | | |
| | | | | compound | | |

Instead of a fixing apparatus B of the Comparative Example shown in FIG. 1 and a fixing apparatus A of the Comparative Example shown in FIG. 2, the fixing apparatus of the image forming apparatus shown in FIG. 6 is used, and the developers 1 to 43 were stored in each developing unit 105D for the formation of images. The developing units 105A to 105C were not used.

### <Lower-Temperature Fixing Property, Hot Offset Resistance, and Thin Line Reproducibility (Initial)>

The developers 1 to 43 were mounted in the image forming apparatus for the output of images. A solid image in a deposit of 0.4 mg/cm² was output on paper (Type 6200 produced by Ricoh Company Ltd.) after exposure, development, and transfer processes. The linear speed of fixing was 160 mm/second.

### —Lower-Temperature Fixing Property and Hot Offset Resistance—

Fixing temperatures were sequentially output with 5° C. increments. A lower limit temperature at which no cold offset occurs (lower limit temperature for fixing: lower-temperature fixing property), and an upper limit temperature at which no hot offset occurs (upper limit temperature for fixing: hot offset resistance), were measured and evaluated on the basis of the following standard. The results are shown in Tables 7-1 and 7-2.

### —Thin Line Reproducibility (Initial)—

Additionally, letter charts (about 2 mm×about 2 mm for the size of one letter) of 5% image area ratio were output with a pulverized toner at the fixing temperature of a lower limit temperature for fixing +20° C., and were visually observed. Thin line reproducibility was evaluated on the basis of the following standard. The results are shown in Tables 7-1 and 7-2.

### (Evaluation Standards of Lower-Temperature Fixing Property)

A: less than 130° C.

B: 130° C. or more and less than 140° C.

C: 140° C. or more and less than 150° C.

D: 150° C. or more and less than 160° C.

E: 160° C. or more

### (Evaluation Standards of Hot Offset Resistance)

A: 200° C. or more

B: 190° C. or more and less than 200° C.

C: 180° C. or more and less than 190° C.

D: 170° C. or more and less than 180° C.

E: less than 170° C.

### (Evaluation Standards of Thin Line Reproducibility (Initial))

A: Extremely good

B: Good

C: Average

D: Acceptable in practical use

E: Unacceptable

### <Smear Resistance>

At the above-described lower limit temperature for fixing, a half tone image of an image area rate of 60% was output on paper (Type 6200 produced by Ricoh Company Ltd.) at a toner deposit of 0.4±0.1 mg/cm². The fixed image portion was rubbed with white cotton cloth (JIS L0803 Cotton No. 3) ten times by using a clock meter, and ID of toner stain deposited on the cloth (mentioned as Smear ID hereinafter) was measured. Smear ID was measured by a colorimeter (X-Rite 938), and smear resistance was evaluated on the basis of the following standard. The pulverized toner 31 was measured at cyan color, and black color was used for the measurement of the other toners. The results are shown in Tables 7-1 and 7-2.

### [Evaluation Standard]

A: Smear ID of 0.20 or less

B: Smear ID of 0.21 to 0.35

C: Smear ID of 0.36 to 0.55

D: Smear ID of 0.56 or above

### <Thin Line Reproducibility (Time Lapse)>

After the initial thin line reproducibility was evaluated, 100,000 sheets of charts with the image area rate of 5% were output while the toner was being supplied. Subsequently, letter charts (about 2 mm×about 2 mm for the size of one letter) of 5% image area ratio were continuously output with a pulverized toner at the fixing temperature of a lower limit temperature for fixing +20° C., and were again visually evaluated, thus carrying out a time lapse evaluation of thin line reproducibility. The judgment standard was the same as for the initial evaluation of thin line reproducibility. The results are shown in Tables 7-1 and 7-2.

### <Heat Resistant Storage Stability>

Each toner was placed at 10 g in a screw vial bottle of 30 mL and was tapped 100 times by a tapping machine, and was then stored in a constant-temperature bath under a 50° C. environment for 24 hours. After the temperature returned to room temperature, the penetration thereof was measured by a penetration testing apparatus, and the heat resistant storage stability thereof was evaluated on the basis of the following standard. The results are shown in Tables 7-1 and 7-2.

### [Evaluation Standard]

A: through
B: 20 mm or more
C: 15 mm or more and less than 20 mm
D: 10 mm or more and less than 15 mm
E: less than 10 mm

TABLE 7-1

| | | Fixing apparatus A of | | | Fixing apparatus B of | | | | | |
|---|---|---|---|---|---|---|---|---|---|---|
| | | example | | | comparative example | | | Thin line | | |
| | | Lower-temp. | | | Lower-temp. | | | reproducibility | | Heat Resistant |
| | | fixing | Hot offset | Smear | fixing | Hot offset | Smear | | Time | Storage |
| | | property | resistance | resistance | property | resistance | resistance | Initial | lapse | Stability |
| Ex. 1A | Toner 1 | A | B | B | E | C | C | A | A | B |
| Comp. | Toner 2 | E | A | B | E | C | D | A | A | D |
| Ex. 1A | | | | | | | | | | |
| Comp. | Toner 3 | A | E | A | B | E | C | A | B | E |
| Ex. 2A | | | | | | | | | | |
| Comp. | Toner 4 | E | A | B | E | B | D | A | A | B |
| Ex. 3A | | | | | | | | | | |
| Comp. | Toner 5 | A | B | B | D | C | C | B | D | E |
| Ex. 4A | | | | | | | | | | |
| Comp. | Toner 6 | E | B | B | E | D | D | A | A | C |
| Ex. 5A | | | | | | | | | | |
| Comp. | Toner 7 | A | E | A | C | E | C | A | B | E |
| Ex. 6A | | | | | | | | | | |
| Ex. 2A | Toner 8 | A | C | B | E | D | C | A | B | C |
| Ex. 3A | Toner 9 | C | B | B | E | D | D | A | A | B |
| Comp. | Toner 10 | E | B | C | E | D | D | A | A | B |
| Ex. 7A | | | | | | | | | | |
| Ex. 4A | Toner 11 | C | B | B | E | D | D | A | A | B |
| Comp. | Toner 12 | E | B | C | E | D | D | A | A | B |
| Ex. 8A | | | | | | | | | | |
| Ex. 5A | Toner 13 | A | D | B | D | E | D | A | A | D |
| Ex. 6A | Toner 14 | B | B | B | D | E | D | A | A | C |
| Ex. 7A | Toner 15 | B | B | B | E | D | D | A | A | B |
| Ex. 8A | Toner 16 | C | B | B | E | D | D | A | A | B |
| Ex. 9A | Toner 17 | A | B | B | D | D | D | A | A | D |
| Ex. 10A | Toner 18 | A | B | B | D | D | D | A | A | C |
| Ex. 11A | Toner 19 | A | B | B | D | D | D | A | A | C |
| Ex. 12A | Toner 20 | A | B | A | D | D | D | A | A | D |
| Ex. 13A | Toner 21 | B | B | B | C | D | D | A | A | C |
| Ex. 14A | Toner 22 | A | B | A | B | E | B | A | A | B |
| Ex. 15A | Toner 23 | B | C | A | B | E | B | A | B | C |

TABLE 7-2

| | | Fixing apparatus A of | | | Fixing apparatus B of | | | | | |
|---|---|---|---|---|---|---|---|---|---|---|
| | | example | | | comparative example | | | Thin line | | |
| | | Lower-temp. | | | Lower-temp. | | | reproducibility | | Heat Resistant |
| | | fixing | Hot offset | Smear | fixing | Hot offset | Smear | | Time | Storage |
| | | property | resistance | resistance | property | resistance | resistance | Initial | lapse | Stability |
| Ex. 16A | Toner 24 | A | C | A | B | E | B | A | B | C |
| Ex. 17A | Toner 25 | B | A | A | E | C | C | A | A | A |
| Ex. 18A | Toner 26 | C | A | A | E | C | C | A | A | A |
| Ex. 19A | Toner 27 | A | C | A | B | E | B | A | B | D |
| Ex. 20A | Toner 28 | A | B | A | B | E | B | A | B | D |
| Ex. 21A | Toner 29 | B | A | A | E | B | C | A | A | A |
| Ex. 22A | Toner 30 | C | A | A | E | B | D | A | A | A |
| Ex. 23A | Toner 31 | A | B | A | C | E | B | A | A | B |
| Ex. 24A | Toner 32 | B | C | A | E | D | D | A | A | A |
| Ex. 25A | Toner 33 | A | B | A | C | E | B | A | A | A |
| Ex. 26A | Toner 34 | A | C | B | C | E | B | A | A | B |
| Ex. 27A | Toner 35 | A | B | A | D | D | D | A | A | A |
| Ex. 28A | Toner 36 | A | B | A | D | D | D | C | D | C |
| Ex. 29A | Toner 37 | B | B | A | E | D | D | B | B | D |
| Comp. | Toner 38 | A | E | A | B | E | B | D | E | E |
| Ex. 9A | | | | | | | | | | |
| Ex. 30A | Toner 39 | A | D | A | B | E | B | C | D | D |
| Ex. 31A | Toner 40 | D | A | B | E | B | D | C | D | C |
| Comp. | Toner 41 | E | A | D | E | B | D | D | E | D |
| Ex. 10A | | | | | | | | | | |
| Ex. 32A | Toner 42 | A | A | A | C | D | D | A | A | B |
| Ex. 33A | Toner 43 | A | A | A | D | B | D | A | A | A |

In the following examples of producing developing sleeves, surface roughness Ra of the developing sleeves was measured by ultra-deep color 3D profile measuring microscope VK-9500 (product of KEYENCE Co., Ltd.). Specifically, their surface profile was measured using an objective lens of ×150 in a measurement range of 90×67 [μm²] at an accuracy of 0.01 μm in the height direction.

### Example 1 of Developing Sleeve Production

### Preparation of Developing Sleeves

An aluminum cylinder of 25 mm in diameter was sprayed with Zn/Al alloy thereon by metal spraying for surface coating, so that a developing sleeve 1 having a surface roughness Ra of 8 μm was prepared.

### Example 2 of Developing Sleeve Production

### Preparation of Developing Sleeves

An aluminum cylinder of 25 mm in diameter was sprayed with Zn/Al alloy thereon by metal spraying for surface coating, and then a titanium nitride layer was formed thereon by a vapor deposition method so as to prepare a developing sleeve 2 having a surface roughness Ra of 8 μm.

### Example 3 of Developing Sleeve Production

### Preparation of Developing Sleeves

An aluminum cylinder of 25 mm in diameter was sprayed with Zn/Al alloy thereon by metal spraying for surface coating, and then a titanium nitride layer was formed thereon by a physical vapor deposition method so as to prepare a developing sleeve 3 having a surface roughness Ra of 10 μm or less.

### Example 4 of Developing Sleeve Production

An aluminum cylinder of 25 mm in diameter was sprayed with Zn/Al alloy thereon by metal spraying for surface coating, and a titanium nitride layer was then formed thereon by a physical vapor deposition method so as to prepare a developing sleeve 4 having a surface roughness Ra of 8 μm or less.

### Example 5 of Developing Sleeve Production

An aluminum cylinder of 25 mm in diameter was sprayed with Zn/Al alloy thereon by metal spraying for surface coating, and a molybdenum oxide layer was then formed thereon by a physical vapor deposition method so as to prepare a developing sleeve 5 having a surface roughness Ra of 10 μm or less.

### Example 6 of Developing Sleeve Production

An aluminum cylinder of 25 mm in diameter was sprayed with Zn/Al alloy thereon by metal spraying for surface coating, and a molybdenum oxide layer was then formed thereon by a physical vapor deposition method so as to prepare a developing sleeve 6 having a surface roughness Ra of 8 μm or less.

### Example 7 of Developing Sleeve Production

A SUS cylinder of 25 mm in diameter was sprayed with Zn/Al alloy thereon by metal spraying for surface coating, and a titanium nitride layer was then formed thereon by a physical vapor deposition method so as to prepare a developing sleeve 7 having a surface roughness Ra of 8 μm or less.

### Example 8 of Developing Sleeve Production

The surface of a SUS cylinder of 25 mm in diameter was sandblasted for roughening, and a titanium nitride layer was then formed thereon by a physical vapor deposition method so as to prepare a developing sleeve 8 having a surface roughness Ra of 8 μm or less.

### Example 9 of Developing Sleeve Production

The surface of a SUS cylinder of 25 mm in diameter was sandblasted for roughening, and then a titanium nitride layer was formed thereon by a physical vapor deposition method so as to prepare a developing sleeve 9 having a surface roughness Ra of 10 μm or less.

### Example 10 of Developing Sleeve Production

The surface of a SUS cylinder of 25 mm in diameter was sandblasted for roughening; then, a titanium nitride layer was formed thereon by a physical vapor deposition method; and furthermore, burr grinding was performed thereto so as to prepare a developing sleeve 10 having a surface roughness Ra of 8 μm or less.

### Example 11 of Developing Sleeve Production

A SUS cylinder of 25 mm in diameter was used for a developing sleeve 11 as it is.

### Examples 1B to 50B and Comparative Examples 1B to 12B

Subsequently, as shown in the following Tables 8-1 and 8-2, the pulverized toners 1 to 43 prepared as described above (toners 1 to 43 in Examples 1A to 33A and Comparative Examples 1A to 10A) and the developing sleeves 1 to 11 prepared as mentioned above were combined and stored in the developing unit 105D of the image forming apparatus shown in FIG. 6. The developing units 105A to 105C were not used.

TABLE 8-1

| Toner Production | Sleeve Production | |
|---|---|---|
| Example | Example | |
| Production Example 1 | 4 | Example 1B |
| Production Example 2 | 4 | Comparative Example 1B |
| Production Example 3 | 4 | Comparative Example 2B |
| Production Example 4 | 4 | Comparative Example 3B |
| Production Example 5 | 4 | Comparative Example 4B |
| Production Example 6 | 4 | Comparative Example 5B |
| Production Example 7 | 4 | Comparative Example 6B |
| Production Example 8 | 4 | Example 2B |
| Production Example 9 | 4 | Example 3B |
| Production Example 10 | 4 | Comparative Example 7B |
| Production Example 11 | 4 | Example 4B |
| Production Example 12 | 4 | Comparative Example 8B |
| Production Example 13 | 4 | Example 5B |
| Production Example 14 | 4 | Example 6B |
| Production Example 15 | 4 | Example 7B |
| Production Example 16 | 4 | Example 8B |
| Production Example 17 | 4 | Example 9B |
| Production Example 18 | 4 | Example 10B |
| Production Example 19 | 4 | Example 11B |
| Production Example 20 | 4 | Example 12B |
| Production Example 21 | 4 | Example 13B |
| Production Example 22 | 4 | Example 14B |
| Production Example 23 | 4 | Example 15B |
| Production Example 24 | 4 | Example 16B |

TABLE 8-2

| Toner Production | Sleeve Production | |
|---|---|---|
| Example | Example | |
| Production Example 25 | 4 | Example 17B |
| Production Example 26 | 4 | Example 18B |
| Production Example 27 | 4 | Example 19B |
| Production Example 28 | 4 | Example 20B |
| Production Example 29 | 4 | Example 21B |
| Production Example 30 | 4 | Example 22B |
| Production Example 31 | 4 | Example 23B |
| Production Example 32 | 4 | Example 24B |
| Production Example 33 | 4 | Example 25B |
| Production Example 34 | 4 | Example 26B |
| Production Example 35 | 4 | Example 27B |
| Production Example 36 | 4 | Example 28B |
| Production Example 37 | 4 | Example 29B |
| Production Example 38 | 4 | Comparative Example 9B |
| Production Example 39 | 4 | Example 30B |
| Production Example 41 | 4 | Comparative Example 10B |
| Production Example 42 | 11 | Comparative Example 11B |
| Production Example 42 | 1 | Example 31B |
| Production Example 42 | 2 | Example 32B |
| Production Example 42 | 3 | Example 33B |
| Production Example 42 | 5 | Example 34B |
| Production Example 42 | 6 | Example 35B |
| Production Example 42 | 7 | Example 36B |
| Production Example 42 | 8 | Example 37B |
| Production Example 42 | 9 | Example 38B |
| Production Example 42 | 10 | Example 39B |
| Production Example 40 | 4 | Example 40B |
| Production Example 43 | 4 | Example 41B |
| Production Example 43 | None | Comparative Example 12B |
| Production Example 43 | 1 | Example 42B |
| Production Example 43 | 2 | Example 43B |
| Production Example 43 | 3 | Example 44B |
| Production Example 43 | 5 | Example 45B |
| Production Example 43 | 6 | Example 46B |
| Production Example 43 | 7 | Example 47B |
| Production Example 43 | 8 | Example 48B |
| Production Example 43 | 9 | Example 49B |
| Production Example 43 | 10 | Example 50B |

Then, <Lower-Temperature Fixing Property, Hot Offset Resistance, and Thin Line Reproducibility (Initial)>, <Smear Resistance>, <Thin Line Reproducibility (Time Lapse)>, and <Heat Resistant Storage Stability> were evaluated as in Example 1A. Image stability was also evaluated as follows. The results are provided in Tables 9-1 and 9-2.

### <Image Stability>

For the evaluation of ghost images, a vertical bar chart shown in FIG. 11 was printed out after 100,000 sheets of letter charts (about 2 mm×about 2 mm for the size of one letter) with the image area rate of 8% were printed. Concentration differences between (a) for one circle around a sleeve and (b) for more than one circle around a sleeve were measured by X-Rite 938 (manufactured by X-Rite Inc.) at three locations of center, rear, and front for average concentration differences (ΔID), and were ranked as follows;

A; Extremely good; B: Good; C: Acceptable; D: Impractical; A, B, C: Pass; D; Fail

### [Evaluation Standard]

A; 0.01≦ΔID

B; 0.01<ΔID≦0.03

C; 0.03<ΔID≦0.06

D; 0.06<ΔID

TABLE 9-1

| | Lower-temp. | Hot | Thin line | Thin line | Heat Resistant | | Image |
|---|---|---|---|---|---|---|---|
| | fixing | offset | reproducebility | reproducebility | Storage | Smear | stability |
| | property | resistance | (initial) | (time lapse) | Stability | resistance | Δ ID |
| Ex. 1B | B | B | A | A | B | B | A |
| Comp. | E | B | A | A | D | B | A |
| Ex. 1B | | | | | | | |
| Comp. | A | E | A | B | E | B | B |
| Ex. 2B | | | | | | | |
| Comp. | E | A | A | A | B | B | B |
| Ex. 3B | | | | | | | |
| Comp. | B | B | B | D | E | B | C |
| Ex. 4B | | | | | | | |
| Comp. | E | C | A | A | C | B | B |
| Ex. 5B | | | | | | | |
| Comp. | B | E | A | B | E | B | C |
| Ex. 6B | | | | | | | |
| Ex. 2B | B | D | A | B | C | B | C |
| Ex. 3B | D | B | A | A | B | B | C |
| Comp. | E | B | A | A | B | B | C |
| Ex. 7B | | | | | | | |
| Ex. 4B | D | B | A | A | B | B | C |
| Comp. | E | B | A | A | B | B | C |
| Ex. 8B | | | | | | | |
| Ex. 5B | B | D | A | A | D | B | C |
| Ex. 6B | B | C | A | A | C | B | B |
| Ex. 7B | C | B | A | A | B | B | C |
| Ex. 8B | D | B | A | A | B | B | C |
| Ex. 9B | B | B | A | A | D | B | C |
| Ex. 10B | B | B | A | A | C | B | C |
| Ex. 11B | A | B | A | A | C | B | C |
| Ex. 12B | A | B | A | A | D | B | C |
| Ex. 13B | B | B | A | A | C | B | B |
| Ex. 14B | A | B | A | A | B | A | B |
| Ex. 15B | B | D | A | B | C | A | C |
| Ex. 16B | B | C | A | B | C | A | C |
| Ex. 17B | C | A | A | A | A | A | C |
| Ex. 18B | D | A | A | A | A | A | C |
| Ex. 19B | A | D | A | B | D | A | C |
| Ex. 20B | A | C | A | B | D | A | C |
| Ex. 21B | C | A | A | A | A | A | C |
| Ex. 22B | D | A | A | A | A | A | C |
| Ex. 23B | A | C | A | A | B | A | C |
| Ex. 24B | C | C | A | A | A | A | B |
| Ex. 25B | A | C | A | A | A | A | B |
| Ex. 26B | A | C | A | A | B | B | B |
| Ex. 27B | A | B | A | A | A | A | B |
| Ex. 28B | A | B | C | D | C | A | C |
| Ex. 29B | C | B | B | B | D | A | B |
| Comp. | A | D | D | E | E | A | D |
| Ex. 9B | | | | | | | |
| Ex. 30B | A | C | C | D | D | A | B |
| Comp. | D | A | D | E | D | A | C |
| Ex. 10B | | | | | | | |
| Comp. | A | A | A | A | B | A | D |
| Ex. 11B | | | | | | | |

TABLE 9-2

| | Lower-temp. | Hot | Thin line | Thin line | Heat Resistant | | Image |
|---|---|---|---|---|---|---|---|
| | fixing | offset | reproducebility | reproducebility | Storage | Smear | stability |
| | property | resistance | (initial) | (time lapse) | Stability | resistance | Δ ID |
| Ex. 31B | A | A | A | A | B | A | B |
| Ex. 32B | A | A | A | A | B | A | B |
| Ex. 33B | A | A | A | A | B | A | A |
| Ex. 34B | A | A | A | A | B | A | C |
| Ex. 35B | A | A | A | A | B | A | A |
| Ex. 36B | A | A | A | A | B | A | A |
| Ex. 37B | A | A | A | A | B | A | B |
| Ex. 38B | A | A | A | A | B | A | B |
| Ex. 39B | A | A | A | A | B | A | B |
| Ex. 40B | C | A | C | D | C | A | A |
| Ex. 41B | A | A | A | A | B | A | A |
| Comp. | A | A | A | A | B | A | D |
| Ex. 12B | | | | | | | |
| Ex. 42B | A | A | A | A | B | A | B |
| Ex. 43B | A | A | A | A | B | A | B |
| Ex. 44B | A | A | A | A | B | A | A |
| Ex. 45B | A | A | A | A | B | A | C |
| Ex. 46B | A | A | A | A | B | A | A |
| Ex. 47B | A | A | A | A | B | A | A |
| Ex. 48B | A | A | A | A | B | A | B |
| Ex. 49B | A | A | A | A | B | A | B |
| Ex. 50B | A | A | A | A | B | A | B |

Aspects of the present invention include, for example, the following.

<1> A toner, including:

a crystalline resin;

a non-crystalline resin; and

a composite resin,

wherein the crystalline resin is a crystalline polyester resin (A),

wherein the non-crystalline resin includes: a non-crystalline resin (B) containing chloroform insoluble matter; and a non-crystalline resin (C) having a softening temperature (T½) that is lower than that of the non-crystalline resin (B) by 25° C. or more,

wherein an absolute value |Tgc−Tgb| of a difference between a glass transition temperature (Tgc) of the non-crystalline resin (C) and a glass transition temperature (Tgb) of the non-crystalline resin (B) is 10° C. or lower,

wherein the composite resin is a composite resin (D) containing a condensation polymerization resin unit and an addition polymerization resin unit, and

wherein the toner has a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the toner.

<2> The toner according to <1>, wherein the toner has an endothermic peak in a range from 90° C. to 130° C. when the endothermic peak is measured by differential scanning calorimetry (DSC).

<3> The toner according to <2>, wherein the toner has an endothermic peak in a range from 90° C. to 130° C. when the endothermic peak is measured by differential scanning calorimetry (DSC), and an endothermic amount at the endothermic peak is between 1 J/g and 15 J/g.

<4> The toner according to any one of <1> to <3>, wherein the non-crystalline resin (C) has a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the non-crystalline resin (C).

<5> The toner according to any one of <1> to <4>, wherein the non-crystalline resin (B) contains the chloroform insoluble matter in an amount of 5% by mass to 40% by mass.

<6> The toner according to any one of <1> to <5>, wherein the crystalline polyester resin (A) contains an ester bond represented by the following general formula in a molecular backbone thereof;

[—OCO—R—COO—(CH₂)ₙ—]

wherein R represents a linear unsaturated aliphatic dicarboxylic acid residue having 2 to 20 carbon atoms; and n is an integer from 2 to 20.

<7> The toner according to any one of <1> to <6>, wherein the condensation polymerization resin unit of the composite resin (C) is a polyester resin unit and the addition polymerization resin unit of the composite resin (C) is a vinyl resin unit.

<8> The toner according to any one of <1> to <7>, further including inorganic fine particles on a surface of the toner.

<9> The toner according to any one of <1> to <8>, further including a fatty acid amide compound.

<10> The toner according to any one of <1> to <9>, further including a salicylic acid metal compound.

<11> An image forming apparatus, including:

an electrostatic latent image bearing member;

an electrostatic latent image forming unit configured to form an electrostatic latent image on the electrostatic latent image bearing member;

a developing unit configured to develop the electrostatic latent image with a toner to form a visible image;

a transfer unit configured to transfer the visible image onto a recording medium; and

a fixing unit configured to fix the visible image transferred on the recording medium;

wherein the developing unit includes a developing sleeve which includes a base and a coating layer on the base, and

wherein the toner is the toner according to any one of <1> to <10>.

<12> The image forming apparatus according to <11>, wherein the coating layer contains at least one kind of elements selected from groups 2 to 6 and groups 12 to 16 of the periodic table of the elements, and the coating layer has a surface roughness (Ra) of 10 μm or less.

<13> The image forming apparatus according to <11> or <12>, wherein the coating layer has a surface roughness (Ra) of 8 μm or less.

<14> The image forming apparatus according to any one of <11> to <13>, wherein the coating layer contains TiN on a surface thereof.

<15> The image forming apparatus according to any one of <11> to <14>, wherein the fixing unit includes:

a heating roller;

a fixing roller containing an elastic layer and arranged in parallel with the heating roller;

a toner heating medium which is an endless belt wound around the heating roller and the fixing roller; and

a pressure roller containing an elastic layer and configured to be pressed against the fixing roller via the toner heating medium and rotated to form a fixing nip portion.

<16> The image forming apparatus according to <15>, wherein the heating roller, the toner heating medium, or both thereof are heated by electromagnetic induction.

<17> The image forming apparatus method according to any one of <11> to <14>, wherein the fixing unit includes:

a heating roller made of a magnetic metal and heated by electromagnetic induction; and

a pressure roller configured to form a fixing nip portion with the heating roller.

<18> An image forming method, including:

forming an electrostatic latent image on an electrostatic latent image bearing member;

developing the electrostatic latent image with a toner to form a visible image;

transferring the visible image onto a recording medium; and

fixing the visible image transferred on the recording medium,

wherein the toner is the toner according to any one of <1> to <10>.

<19> The image forming method according to <18>, wherein the developing is performed with a developing unit, and wherein the developing unit includes a developing sleeve which includes a base and a coating layer on the base.

<20> The image forming method according to <18> or <19>, wherein the coating layer contains at least one kind of elements selected from groups 2 to 6 and groups 12 to 16 of the periodic table of the elements, and the coating layer has a surface roughness (Ra) of 10 μm or less.

This application claims priority to Japanese application No. 2012-076205, filed on Mar. 29, 2012, and Japanese application No. 2012-079706, filed on Mar. 30, 2012, and incorporated herein by reference.

What is claimed is:

1. A toner, comprising:
a crystalline resin;
a non-crystalline resin; and
a composite resin,
wherein the crystalline resin is a crystalline polyester resin (A),
wherein the non-crystalline resin comprises: a non-crystalline resin (B) containing chloroform insoluble matter; and a non-crystalline resin (C) having a softening temperature (T½) that is lower than that of the non-crystalline resin (B) by 25° C. or more,
wherein an absolute value |Tgc−Tgb| of a difference between a glass transition temperature (Tgc) of the non-crystalline resin (C) and a glass transition temperature (Tgb) of the non-crystalline resin (B) is 10° C. or lower,
wherein the composite resin is a composite resin (D) containing a condensation polymerization resin unit and an addition polymerization resin unit, and
wherein the toner has a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the toner.

2. The toner according to claim 1, wherein the toner has an endothermic peak in a range from 90° C. to 130° C. when the endothermic peak is measured by differential scanning calorimetry (DSC).

3. The toner according to claim 2, wherein the toner has an endothermic peak in a range from 90° C. to 130° C. when the endothermic peak is measured by differential scanning calorimetry (DSC), and an endothermic amount at the endothermic peak is between 1 J/g and 15 J/g.

4. The toner according to claim 1, wherein the non-crystalline resin (C) has a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the non-crystalline resin (C).

5. The toner according to claim 1, wherein the non-crystalline resin (B) comprises the chloroform insoluble matter in an amount of 5% by mass to 40% by mass.

6. The toner according to claim 1, wherein the crystalline polyester resin (A) comprises an ester bond represented by the following general formula in a molecular backbone thereof:
[—OCO—R—COO—(CH₂)ₙ—]
wherein R represents a linear unsaturated aliphatic dicarboxylic acid residue having 2 to 20 carbon atoms; and n is an integer from 2 to 20.

7. The toner according to claim 1, wherein the condensation polymerization resin unit of the composite resin (C) is a polyester resin unit and the addition polymerization resin unit of the composite resin (C) is a vinyl resin unit.

8. The toner according to claim 1, further comprising inorganic fine particles on a surface of the toner.

9. The toner according to claim 1, further comprising a fatty acid amide compound.

10. The toner according to claim 1, further comprising a salicylic acid metal compound.

11. An image forming apparatus, comprising:
an electrostatic latent image bearing member;
an electrostatic latent image forming unit configured to form an electrostatic latent image on the electrostatic latent image bearing member;
a developing unit configured to develop the electrostatic latent image with a toner to form a visible image;
a transfer unit configured to transfer the visible image onto a recording medium; and
a fixing unit configured to fix the visible image transferred on the recording medium;
wherein the developing unit comprises a developing sleeve which comprises a base and a coating layer on the base, and
wherein the toner comprises:
a crystalline resin;
a non-crystalline resin; and
a composite resin,
wherein the crystalline resin is a crystalline polyester resin (A),
wherein the non-crystalline resin comprises: a non-crystalline resin (B) containing chloroform insoluble matter; and a non-crystalline resin (C) having a softening temperature (T½) that is lower than that of the non-crystalline resin (B) by 25° C. or more,
wherein an absolute value |Tgc−Tgb| of a difference between a glass transition temperature (Tgc) of the non-crystalline resin (C) and a glass transition temperature (Tgb) of the non-crystalline resin (B) is 10° C. or lower,
wherein the composite resin is a composite resin (D) containing a condensation polymerization resin unit and an addition polymerization resin unit, and
wherein the toner has a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the toner.

12. The image forming apparatus according to claim 11, wherein the coating layer comprises at least one kind of elements selected from groups 2 to 6 and groups 12 to 16 of the periodic table of the elements, and the coating layer has a surface roughness (Ra) of 10 μm or less.

13. The image forming apparatus according to claim 11, wherein the coating layer has a surface roughness (Ra) of 8 μm or less.

14. The image forming apparatus according to claim 11, wherein the coating layer comprises TiN on a surface thereof.

15. The image forming apparatus according to claim 11, wherein the fixing unit comprises:
a heating roller;
a fixing roller comprising an elastic layer and arranged in parallel with the heating roller;
a toner heating medium which is an endless belt wound around the heating roller and the fixing roller; and
a pressure roller comprising an elastic layer and configured to be pressed against the fixing roller via the toner heating medium and rotated to form a fixing nip portion.

16. The image forming apparatus according to claim 15, wherein the heating roller, the toner heating medium, or both thereof are heated by electromagnetic induction.

17. The image forming apparatus according to claim 11, wherein the fixing unit comprises:
a heating roller made of a magnetic metal and heated by electromagnetic induction; and
a pressure roller configured to form a fixing nip portion with the heating roller.

18. An image forming method, comprising:
forming an electrostatic latent image on an electrostatic latent image bearing member;
developing the electrostatic latent image with a toner to form a visible image;
transferring the visible image onto a recording medium; and
fixing the visible image transferred on the recording medium,
wherein the toner comprises:
a crystalline resin;
a non-crystalline resin; and
a composite resin,
wherein the crystalline resin is a crystalline polyester resin (A),
wherein the non-crystalline resin comprises: a non-crystalline resin (B) containing chloroform insoluble matter; and a non-crystalline resin (C) having a softening temperature (T½) that is lower than that of the non-crystalline resin (B) by 25° C. or more,
wherein an absolute value |Tgc−Tgb| of a difference between a glass transition temperature (Tgc) of the non-crystalline resin (C) and a glass transition temperature (Tgb) of the non-crystalline resin (B) is 10° C. or lower,
wherein the composite resin is a composite resin (D) containing a condensation polymerization resin unit and an addition polymerization resin unit, and
wherein the toner has a molecular weight distribution having a main peak in a range of 1,000 to 10,000 and a half width of 15,000 or less, where the molecular weight distribution is obtained by gel permeation chromatography (GPC) of tetrahydrofuran (THF) soluble matter of the toner.

19. The image forming method according to claim 18, wherein the developing is performed with a developing unit, and wherein the developing unit comprises a developing sleeve which comprises a base and a coating layer on the base.

20. The image forming method according to claim 18, wherein the coating layer comprises at least one kind of elements selected from groups 2 to 6 and groups 12 to 16 of the periodic table of the elements, and the coating layer has a surface roughness (Ra) of 10 μm or less.
